(19) United States
(12) Patent Application Publication
(10) Pub. No.: US 2024/0232745 A1
(43) Pub. Date: Jul. 11, 2024

(54) DYNAMIC AND INTERACTIVE SKILLS IDENTIFICATION SYSTEMS AND METHODS

(71) Applicant: Matthew HOFFBERG, Bloomington, MN (US)

(72) Inventor: Matthew HOFFBERG, Bloomington, MN (US)

(21) Appl. No.: 18/577,235

(22) PCT Filed: Jul. 11, 2022
(86) PCT No.: PCT/US2022/036632

§ 371 Date: Jan. 5, 2024

Related U.S. Application Data
(60) Provisional application No. 63/221,363, filed on Jul. 13, 2021.

(51) Int. Cl. G06Q 10/0631; G06F 9/451

(52) U.S. Cl. CPC G06Q 10/063112; G06F 9/451

(57) ABSTRACT

Systems and methods of the present disclosure provide for user skill identification on a graphical user interface. The method includes displaying a spider web graph including multiple radial axes corresponding to multiple career skills. Each radial axis includes a plurality of skill level indications. The method further includes displaying multiple user skillsets on the spider web graph. Each user skillset corresponds to a respective radial axis and a skill level indication associated with the respective radial axis. The method further include receiving a user input to determine multiple updated skillsets and in response to the user input, dynamically updating the graphical user interface to display the multiple updated skillsets on the spider web graph.

### CROSS-REFERENCE TO RELATED APPLICATIONS

This application claims priority to U.S. Provisional Application No. 63/221,363, titled Skills Marketplace, filed on Jul. 13, 2021, which is hereby incorporated by reference in its entirety.

### FIELD OF THE INVENTION

This disclosure relates to the field of systems and methods configured to identify users' skills based on their experience and learning to improve their current or potential career and apply these skills to fill skills gaps in organizations.

### SUMMARY OF THE INVENTION

The present disclosure relates to systems and methods including one or more server hardware computing devices or client hardware computing devices, communicatively coupled to a network, and each including at least one processor in communication with a memory configured to: determine a plurality of career skills; display a spider web graph comprising a plurality of radial axes corresponding to the plurality of career skills, each radial axis of the plurality of radial axes comprising a plurality of skill level indications; determine a plurality of user skillsets corresponding to the plurality of career skills, each user skillset of the plurality of user skillsets comprising a career skill and a user skill level indication of the career skill; display the plurality of user skillsets on the spider web graph, each user skillset of the plurality of user skillsets corresponding to a respective radial axis of the plurality of radial axes and a skill level indication of the plurality of skill level indications associated with the respective radial axis; receive a first user input to determine a plurality of updated skillsets; and in response to the first user input, dynamically update the graphical user interface to display the plurality of updated skillsets on the spider web graph.

The present disclosure provides systems and methods comprising one or more server hardware computing devices or client hardware computing devices, communicatively coupled to a network, and each comprising at least one processor executing specific computer-executable instructions within a memory that, when executed, cause the system to deconstruct any job into its skills, allowing users, such as learners, current employees, and employers to understand users' skills in order to unlock skills and mobilize talent, while also establishing trust and confidence.

The above features and advantages of the present invention will be better understood from the following detailed description taken in conjunction with the accompanying drawings.

### BRIEF DESCRIPTION OF THE DRAWINGS

FIG. 1 illustrates a system level block diagram for identifying users' skills based on their experience and learning to improve their current or potential career and apply these skills to fill skills gaps in organizations.

FIG. 2 illustrates a system level block diagram for identifying users' skills based on their experience and learning to improve their current or potential career and apply these skills to fill skills gaps in organizations.

FIG. 3 illustrates a non-limiting example embodiment of a user interface used to identify users' skills based on their experience and learning to improve their current or potential career and apply these skills to fill skills gaps in organizations.

FIG. 4 illustrates a non-limiting example embodiment of a user interface used to identify users' skills based on their experience and learning to improve their current or potential career and apply these skills to fill skills gaps in organizations.

FIG. 5 illustrates a non-limiting example embodiment of a user interface used to identify users' skills based on their experience and learning to improve their current or potential career and apply these skills to fill skills gaps in organizations.

FIG. 6 illustrates a non-limiting example embodiment of a user interface used to identify users' skills based on their experience and learning to improve their current or potential career and apply these skills to fill skills gaps in organizations.

FIGS. 7A-7E illustrate non-limiting example embodiments of user interfaces used to identify users' skills based on their experience and learning to improve their current or potential career and apply these skills to fill skills gaps in organizations.

FIG. 8 illustrates a non-limiting example embodiment of a user interface used to identify users' skills based on their experience and learning to improve their current or potential career and apply these skills to fill skills gaps in organizations.

FIG. 9A-9S illustrate non-limiting example embodiments of user interfaces used to identify users' skills based on their experience and learning to improve their current or potential career and apply these skills to fill skills gaps in organizations.

FIG. 10A-10H illustrate non-limiting example embodiments of user interfaces used to identify users' skills based on their experience and learning to improve their current or potential career and apply these skills to fill skills gaps in organizations.

FIG. 11A-11B illustrate non-limiting example embodiments of user interfaces used to identify users' skills based on their experience and learning to improve their current or potential career and apply these skills to fill skills gaps in organizations.

FIG. 12A-12B illustrate non-limiting example embodiments of user interfaces used to identify users' skills based on their experience and learning to improve their current or potential career and apply these skills to fill skills gaps in organizations.

FIG. 13 illustrates a non-limiting example of a flowchart describing an example method and technique for user skill identification on a graphical user interface, in accordance with various aspects of the technique described in this disclosure.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

In general, workplaces and job titles within those workplaces are becoming more disaggregated. Current trends demonstrate that many employees work on multiple projects that stretch current definitions of what it is to be, for example, a “project manager,” a “product manager,” a “data scientist,” etc.

With a billion jobs destined to be transformed by 2030, the future of work demands new skills and more flexible careers. In the current job market, looking at work experience as a series of jobs is becoming less relevant the faster jobs are changing. Talent needs to be more mobile. Service providers need be the engine of a better talent market, connecting learning to skills, people to learning and learning to work, in a seamless, dynamic and equitable way.

Job seekers and learners learn every day, and with so much material available (videos, articles, podcasts, courses, etc.), it's difficult for users and service providers to determine how to cut through the noise, discover what's most relevant to the user, build trusted learning into their daily life, and share learning with others. Thus, employers and job seekers, or those looking to improve their current job, need to reframe experience around skills to build transferability.

To approach these issues, the disclosed embodiments follow the rationale of deconstructing any job into its skills, allowing users, such as learners, current employees, and employers to understand users' skills in order to unlock skills and mobilize talent, while also establishing trust and confidence. To accomplish this, the disclosed embodiments bring together the measurement, learning, and signaling of critical workforce skills in one place, around a unifying global scale, so that employers and employees can use validated insights to measure what skills they have, learn what they need, and show what they can do. The disclosed system therefore transcends existing learning and identified talent into a marketplace platform designed to reshape the market around verified skills, using a skills marketplace to connect those skills to people and opportunities.

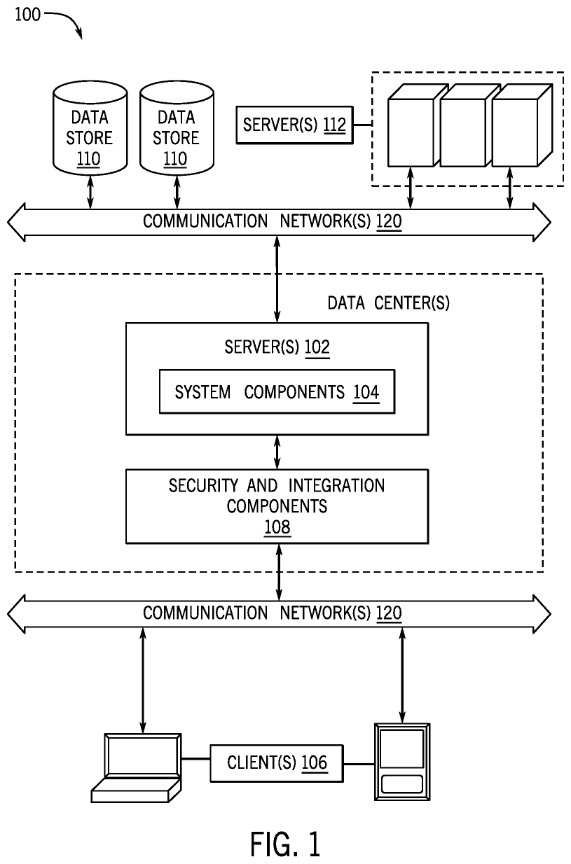

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone network (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

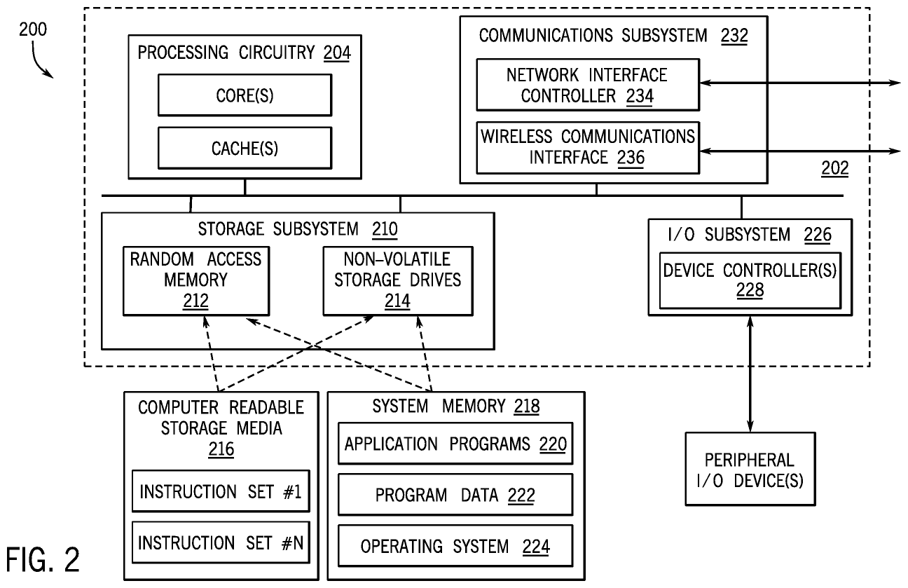

The embodiments shown in FIGS. 1-2 are thus one example of a distributed computing system and are not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

As noted above, the disclosed embodiments may include a skills marketplace, which brings together the measurement, learning and signaling of critical workforce skills in one place, around a unifying global scale, so that employers and employees can use validated insights to measure what skills they have, learn what they need, and show what they can do. The disclosed embodiments represent an improvement to a workforce strategy emphasizing a skills-based product development (e.g., Pearson Education's Workforce Skills, representing a loose collection of existing Pearson products).

The loose collection referred to above may include five separate product vision or opportunity areas, each representing 5 particular business or marketing opportunity areas, explored in greater detail below. These five opportunity areas may be further mixed and matched with one another into groupings. As a non-limiting example, in some embodiments, the first, second, and fifth opportunity areas, described below, may be grouped together as a first, collaborative, single product strategy opportunity initiative, and the third and fourth opportunity areas, also described below, may be grouped together as a second, collaborative, single product strategy opportunity initiative. Each of these opportunity areas or opportunity initiatives may involve third party partnerships, providing means to extend the disclosed embodiments.

As noted above, in some embodiments, different product or opportunity areas may be combined together. As a non-limiting example, the first product opportunity area may be combined with the fifth product opportunity area, both described in more detail below. At a high level, some of these embodiments may include a 3-step cycle:

The first step in the 3-step cycle may include working on projects, so that employees may work on projects tagged by skills and domain knowledge. As a non-limiting example, a user may work on building a business case for a specific product or project, and that project may further have skills associated with it, such as “business acumen” or “managing stakeholders,” or the like. In order to complete that project successfully, the employee may require a skill level at a certain high level on a scale (e.g., a 7 or 8 on a global scale of skills, described in more detail below) for those two different skills.

The second step in the 3-step cycle may include getting verified skills. When a user works on projects that are tagged by skills and domain knowledge, upon completing those projects, employees' skills and knowledge may be verified by certified coaches, which may include managers, peers and/or mentors from the same or different organization. Once those projects are completed, those skills may become verified skills in the user's skills profile, so that any employer can view the user's skill profile, as described in more detail below, regarding the skills demonstrated from the project.

The third step in the 3-step cycle may include unlocking new projects. Some of these projects may not be available to the members of the team, because they require skills that the team members don't yet have. Upon verifying skills, employees can access projects tagged by higher skill and knowledge levels. When users have these verified skills, the disclosed embodiments may unlock new projects that the user may now have access to. As non-limiting examples, the projects worked on may be projects that are visible within an employer user interface, described below, and include projects that a team lead may assign to their team, or those projects that are currently in the team's backlog, which are associated with particular skills. The 3-step cycle therefore becomes a “virtuous” cycle so that as members of a team are upskilling, the team leads may unlock new projects to work on, which then unlocks further projects, and so on. Thus, the members of the team add value not just to themselves, but also to their teams or to the workforce of their organization overall.

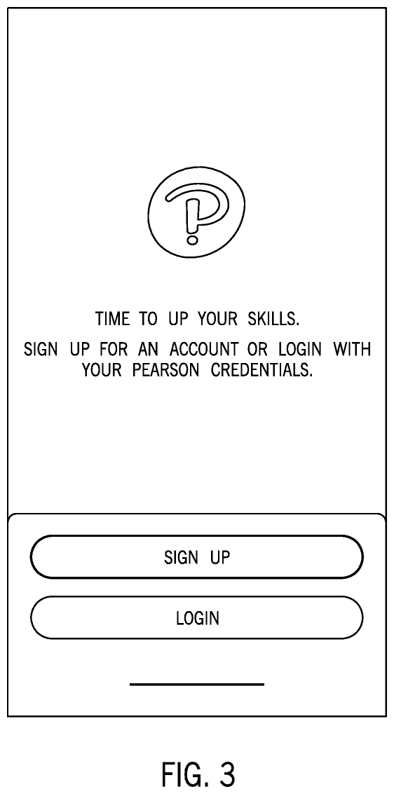

Considering the first product opportunity area in more detail, this product opportunity area accomplishes the broad purpose of using a hosting and/or product provider (e.g., Pearson Education's) expertise, skills assessments, frameworks, and credentials to help address employers' challenges in upskilling and talent mobility. The non-limiting example user interfaces shown in FIGS. 3-10H, described in more detail below, may be broken into 4 main areas, comprising 1. Onboarding, 2. User Profile, 3. Learning Experience, and 4. Company Profile.

Turning now to FIG. 3, the disclosed embodiments may include an onboarding software module. For this onboarding software module, the main idea is to provide an environment in which an individual may create an account with an organization. In the non-limiting example embodiment in FIG. 3, this organization may be Pearson Education.

In some embodiments, server 112 may execute one or more software instructions running within one or more software modules, which are configured to generate a graphical user interface (GUI) such as that seen in the non-limiting example embodiment in FIG. 3. This GUI may be transmitted through network 120 and displayed on a client device 106, such as a desktop computer, laptop computer, cell phone, etc. The GUI may include one or more GUI components for receiving user input. In the example embodiment in FIG. 3, the user may select to sign up or login to the disclosed system. This user input may be received by the client device 106 and transmitted through the network 120 to server 112. The server software may then store the account information for the user and/or authenticate the user to access the data in data store 110 (e.g., username and password).

In some embodiments, once the user account profile is established, the user may then upload data, documents, or any other resources needed in the disclosed embodiments. To accomplish this, server 112 may generate a GUI (not shown in FIG. 3) including one or more GUI components for the user to input and/or upload the additional resources to be associated with the account. Client device 106 may then transmit this data through network 120 to server 112, which may then store the data in data store 110 in association with the user account profile. In some embodiments, this data may include skills associated with the user for which the account was created and stored.

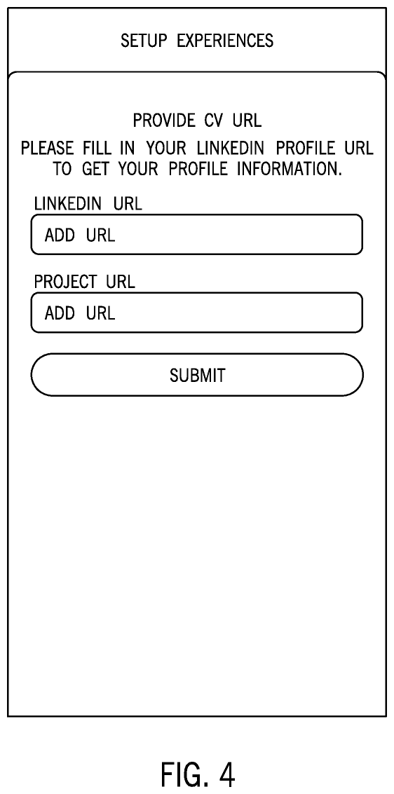

Turning now to FIG. 4, as an additional step to setting up the user's account, described above, a user may provide Uniform Resource Locators (URLs) for various social and professional media accounts, completed projects, and the like. It should be noted that, in some embodiments, the intent of these embodiments is different from, for example, a LinkedIn profile.

In some embodiments, one or more server software modules may execute instructions to generate a GUI such as that seen in the non-limiting example embodiment in FIG. 4. This GUI, which may include one or more GUI components for receiving user input, may be transmitted through network 120 and displayed on client device 106. In the example embodiment in FIG. 4, the user may input the URL for a social or professional profile, a GitHub account, one or more projects that the user has worked on, or any other date demonstrating evidence of the user's experience or skills. This user input may be received by the client device 106 and transmitted through the network 120 to server 112.

The server software may then store the received evidence of a user's experience or skills and store this data in data store 110. In some embodiments, in addition to receiving input and storing received data for a social or professional media account, user projects, or other experience or skills, the server software may then access additional data from the URLs provided (e.g., by accessing an API for these resources), and may download, parse, and/or analyze the data received from these sources, in order to extract from the user's history, and identify, within the user's history skills that the user may have, possibly by parsing text strings, and the like.

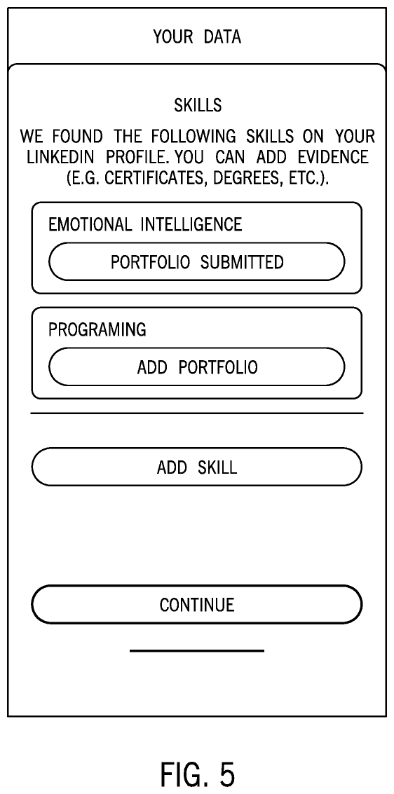

Turning now to FIG. 5, the skills identified within the received and stored data may be displayed to the user for confirmation, and the user may have the opportunity to provide additional skills and experience, as well as additional data to the user portfolio. This additional data may include any data used to fill and/or continue to build the user's set of skills and identify what the user can and cannot do.

In some embodiments, one or more server software modules may execute instructions to parse and otherwise analyze the received and stored skill and experience data to identify one or more skills or experiences associated with the user account. In some embodiments, each of these skills or experiences may be associated in the data store 110 with one or more categories. Server 112 may then generate a GUI such as that seen in the non-limiting example embodiment in FIG. 5. This GUI may include the skills identified as associated with the user account, as well as any experiential or evidence data supporting these skills, such as a user portfolio, and the categories associated with these skills, in some embodiments.

As seen in FIG. 5, the generated GUI may further include GUI components allowing the user to upload or otherwise input this additional evidence. Once received by the GUI on the client device 106, this data may be transmitted through the network 120 and stored on server 112 in data store 110.

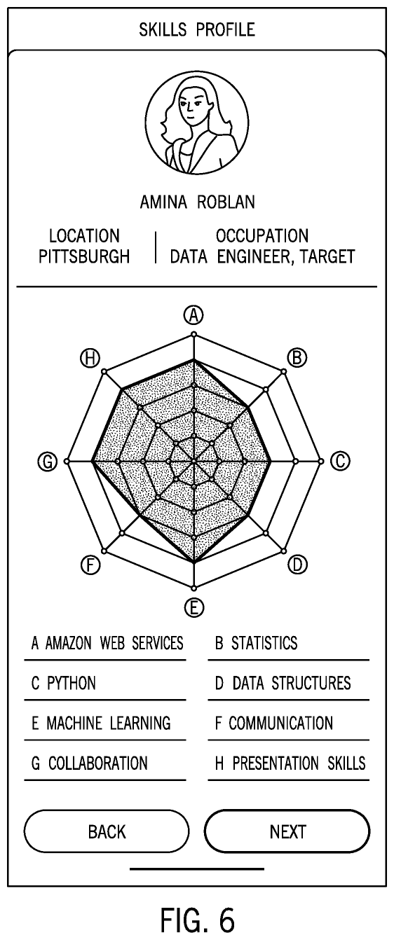

Turning now to FIG. 6, once all of the skill, experience, and/or evidence data has been stored in data store 110, one or more server software modules may receive, possibly from client device 106, a request to view user profile data for a specific user. In response to this request, in some embodiments, the server software may execute a database request to select the data from the user account, stored in data store 110 and associated with the user that generated the request. The server software may then analyze this data to determine a user skill level for each of the skills associated with the user, based on the skill, experience, and/or other evidence data stored in data store 110.

Once the skill data has been analyzed, the server software may execute instructions to generate a GUI such as that seen in the non-limiting example embodiment in FIG. 6. This GUI may include a display of the user data, such as the user's name (“Amina Roblan”), location (“Pittsburgh”), and occupation (“Data Engineer, Target”). The GUI may further include some type of graphic, such as the example “spider web” graphic in FIG. 6, generated from the skill, experience, and/or evidence data associated with the user account. In the example embodiment in FIG. 6, each of the user's skills is listed and the spiderweb graphic demonstrates the user's proficiencies within the user's skillset as a single graphic. This graphic or chart is intended to represent a set of skills that this individual has.

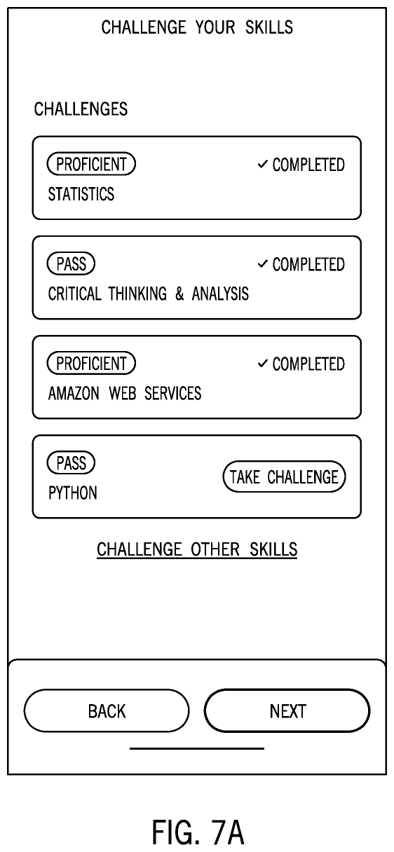

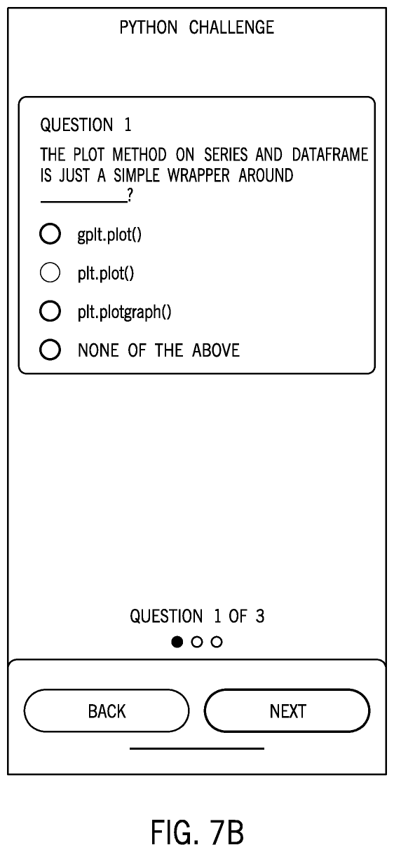

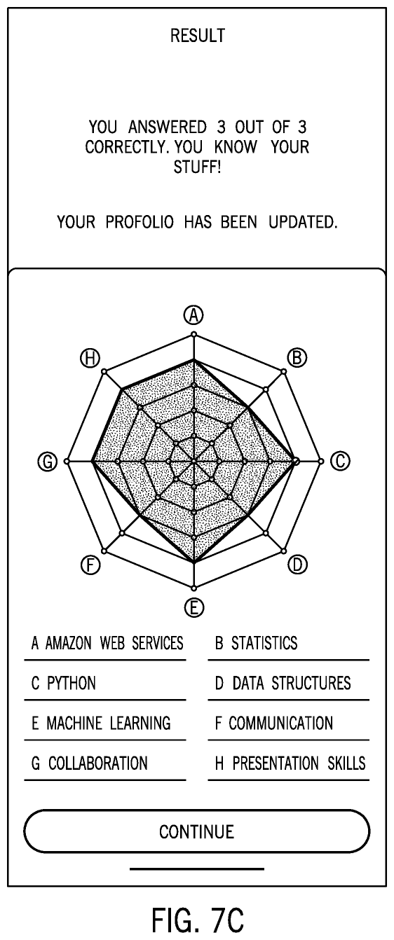

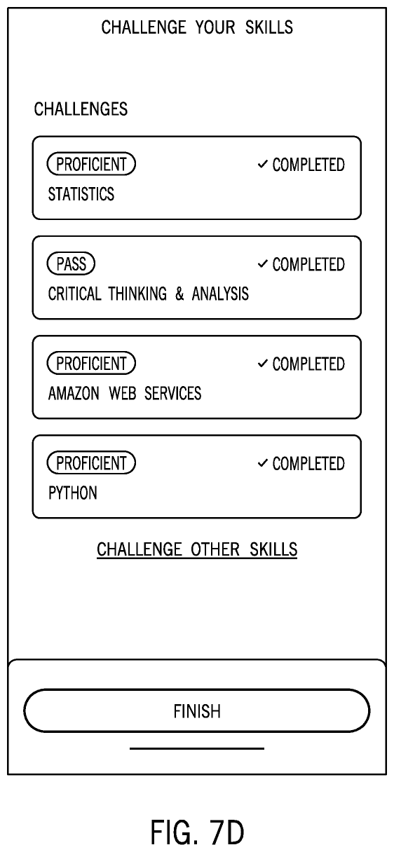

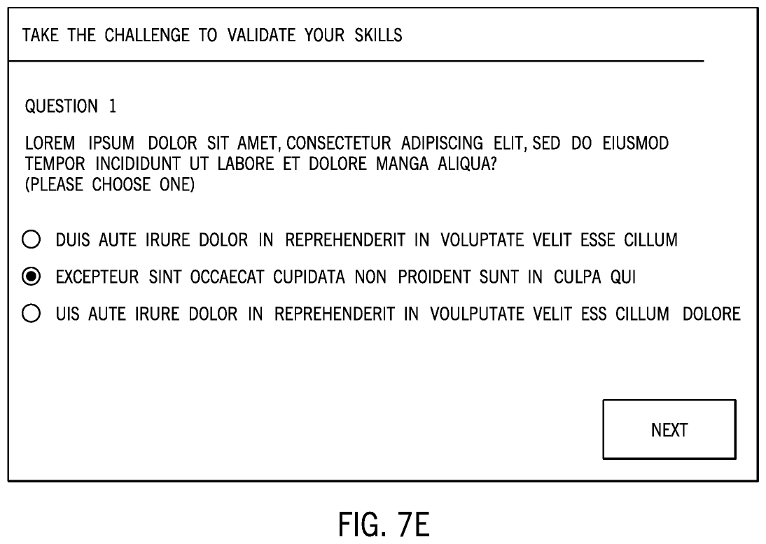

Turning now to FIGS. 7A-7E, once the user's skills have been identified, the disclosed system may provide the user challenges, which help to validate that the skills identified for the user. This approach may represent an improvement over existing systems, which only state that a user has been validated (e.g., by a friend or product manager for a skill related to a specific product, for example), in that it provides validation other than the word of a friend or co-worker. In the disclosed embodiments, the system may create mini tests, each containing only a few questions that are complex enough to prove out specific skills, and whether or not the user knows how to demonstrate that skill, or the knowledge of what it is.

Thus, using FIG. 7A as an example, the disclosed system may generate and display to the user, on the client device, a GUI including a list of available challenges, a status of whether or not specific challenges have or have not been completed by the user, and GUI components allowing a user to input a request to take any challenges that have not already been taken. The GUI may then receive a user input indicating a desire to take an uncompleted challenge and transmit this data through the network 120 to the server 112.

Turning now to FIG. 7B, in response to receiving the request to take a challenge, server 112 may select the data for the identified challenge, possibly stored in data store 110, and use this data to generate a GUI presenting the challenge question to the user, and transmit this GUI through network 120 to the client device 106 for display. In the non-limiting example in FIG. 7B, the specific example here is a Python software language challenge, dealing with a user that knows Python, asking about a plot method. The user may review the question, and provide user input into the GUI, which is transmitted through network 120 to server 112. The server software may then compare the input response with a correct response, possibly in data store 110, to determine if the input response was correct. The server software may repeat the steps above until all challenge questions have been completed.

Turning now to FIG. 7C, as each new question is generated, displayed, and responded to, the disclosed system may keep a running tally of the results of each of the challenge questions in the challenge, and using the results of the challenge, may update the content to reflect the results of the challenge, and further update the data for the progress indicator, such as the spiderweb graphic in FIG. 7C, and the skills associated with that challenge as affected by the results of the challenge. The user portfolio may be updated in data store 110 accordingly, and the GUI may then be transmitted through network 120 for display on the client device 106.

Similarly, as seen in FIG. 7D, the disclosed system may update the data in data store 110 to reflect completion of the challenge, and may generate a GUI reflecting the updated data, including the completion of the challenge. FIG. 7E represents a possible alternative GUI used for providing a challenge to users.

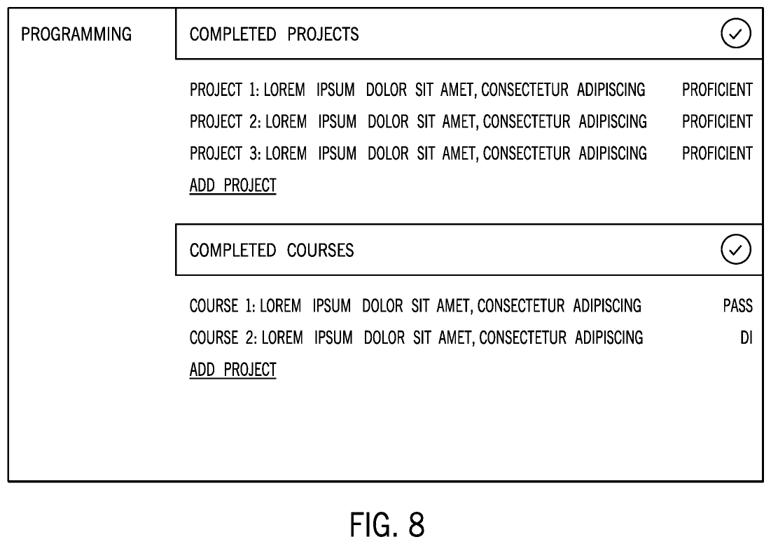

Turning now to FIG. 8, in addition to the completion and results from the coding challenges, the disclosed system may be configured to receive additional evidence of the user's skills and experience. This other evidence include may include, as non-limiting examples, a rubric that the user's manager used to express that a user is great at product management, and detailing what the user does well, and doesn't do well, etc. As another example, if the user were a UX/UI designer, the additional evidence could include a design that's in the user's portfolio. Finally, as demonstrated in FIG. 8, additional evidence or experience to demonstrate a user's skills may include completed projects and/or completed learning courses associated with the user's profile account. There are therefore different types of evidence and different ways that the disclosed system would measure different skills.

The disclosed system may generate and display, on the client device 106, a GUI (not shown) for receiving such additional evidence and experience associated with a user's skills and the user's profile account. This GUI may include one or more GUI components configured to receive user input or uploads demonstrating the user's skill set. This data may be transmitted through network 120 to server 112, and the disclosed system may then process the received uploads or input, and store this received data in data store 110 in association with the user's profile account.

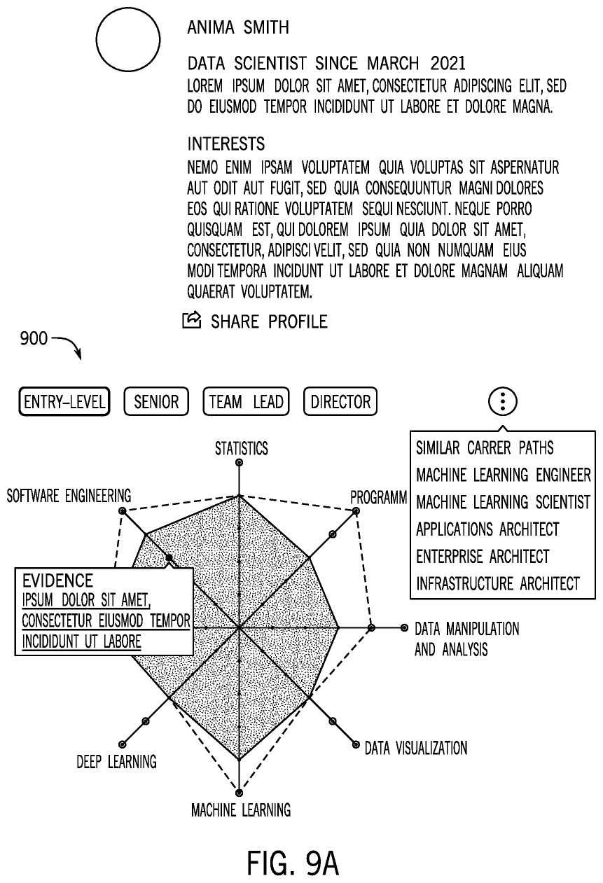

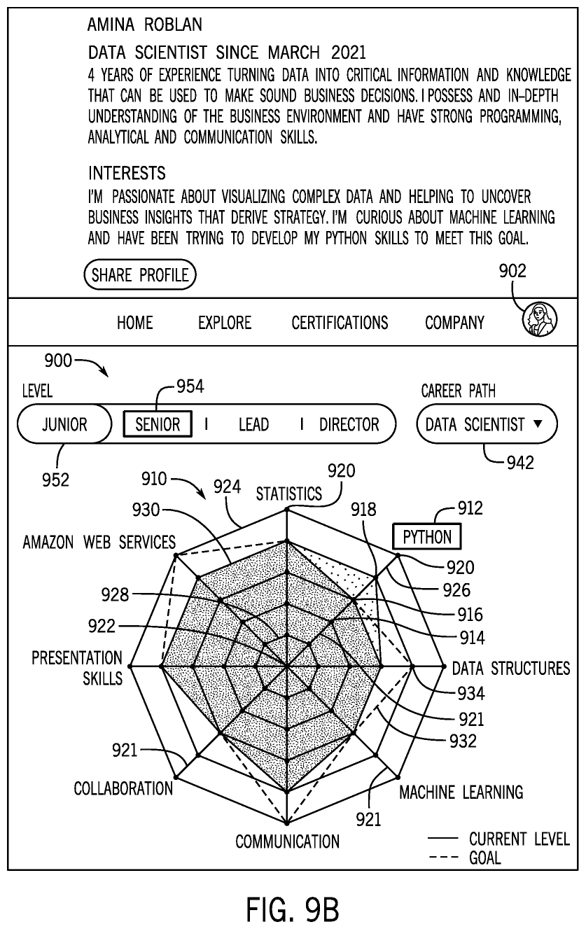

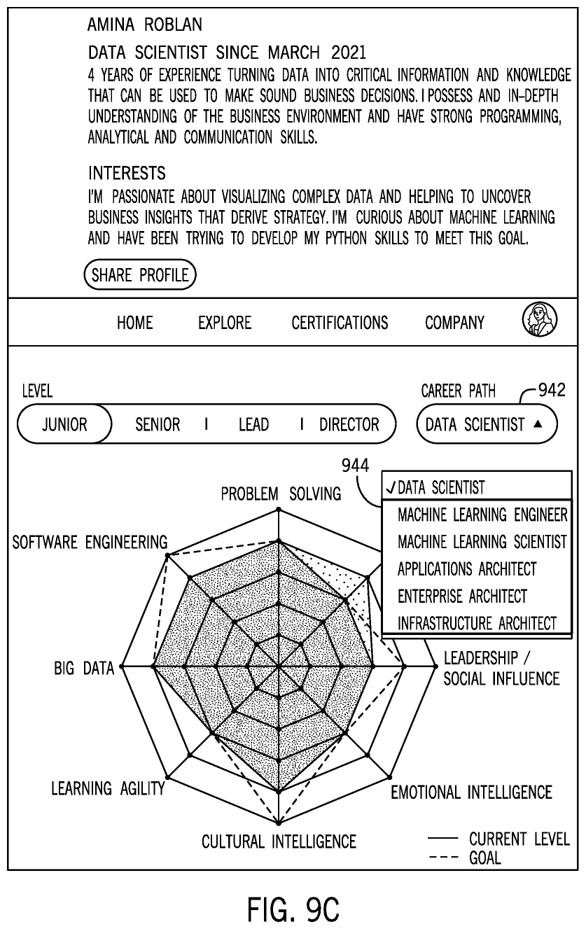

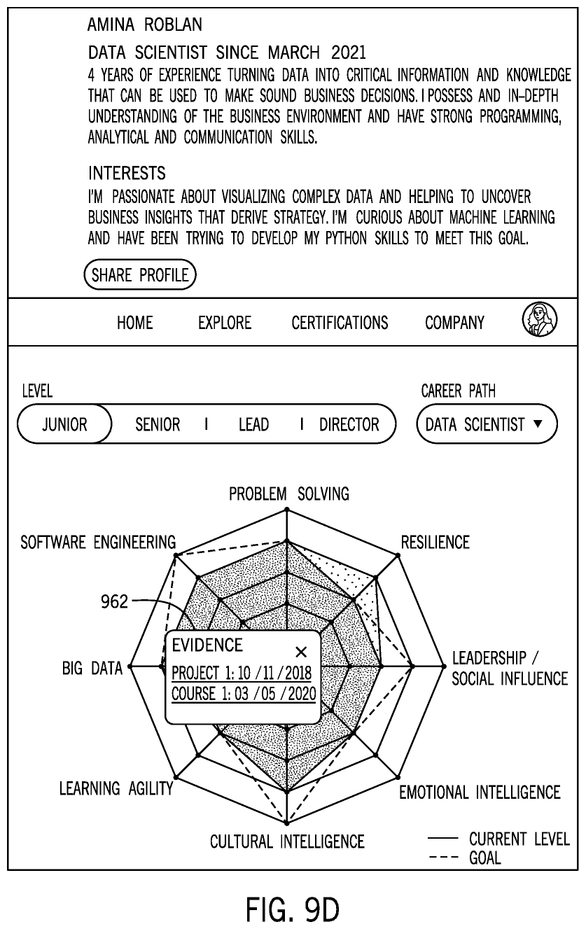

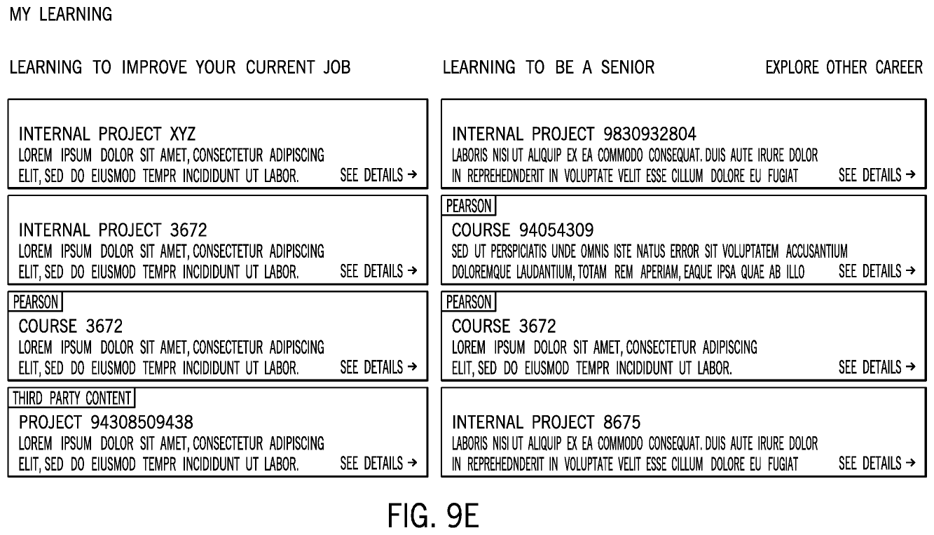

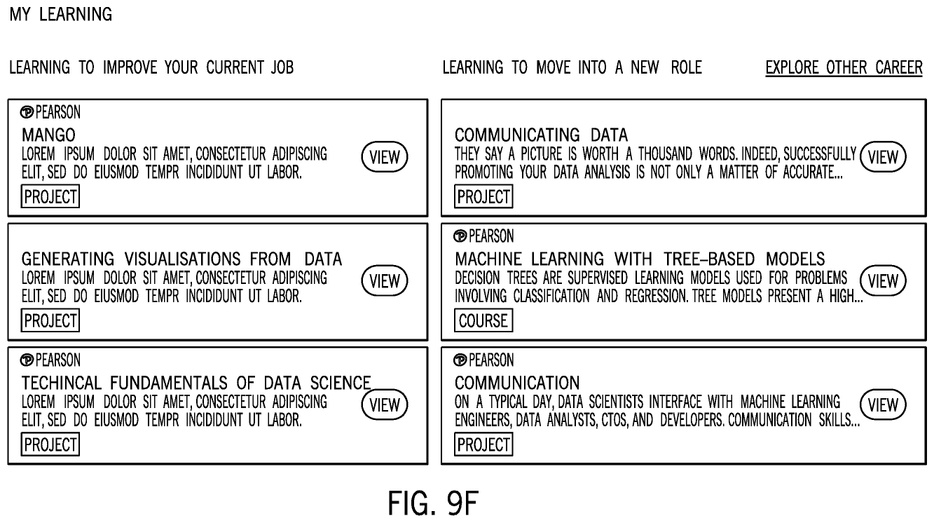

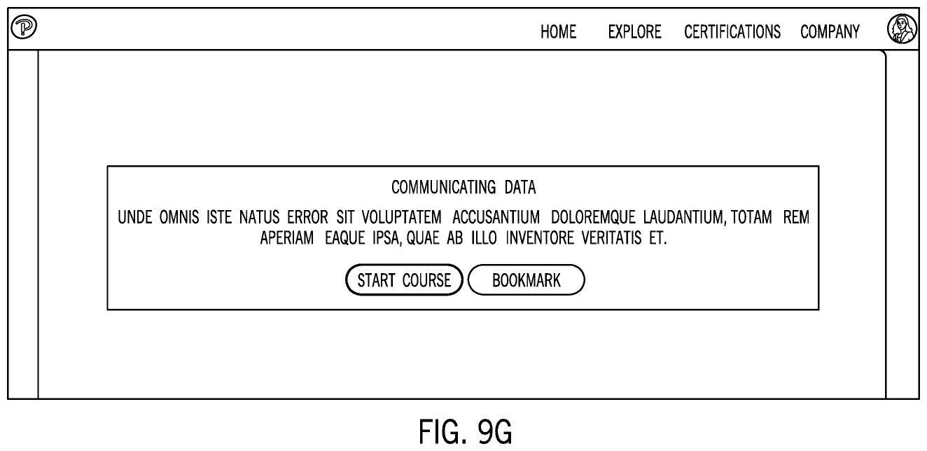

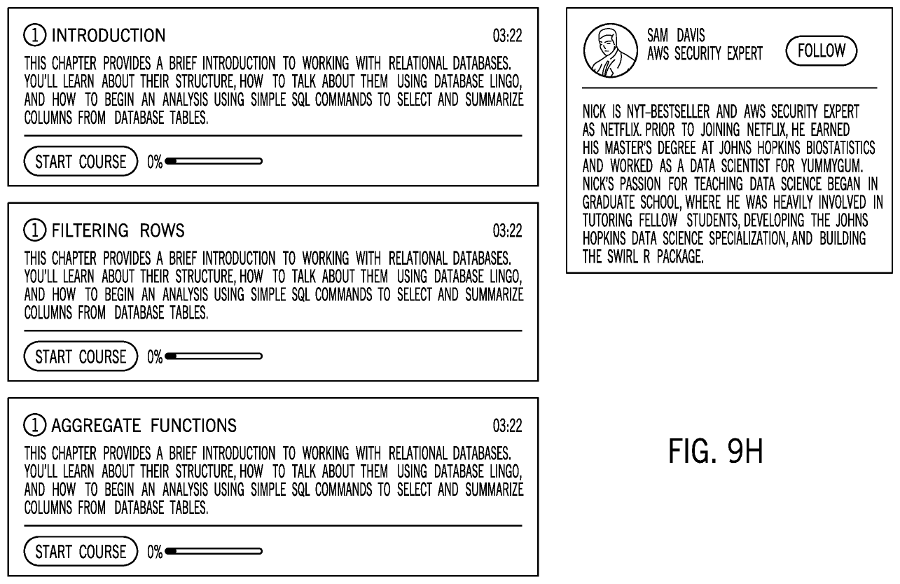

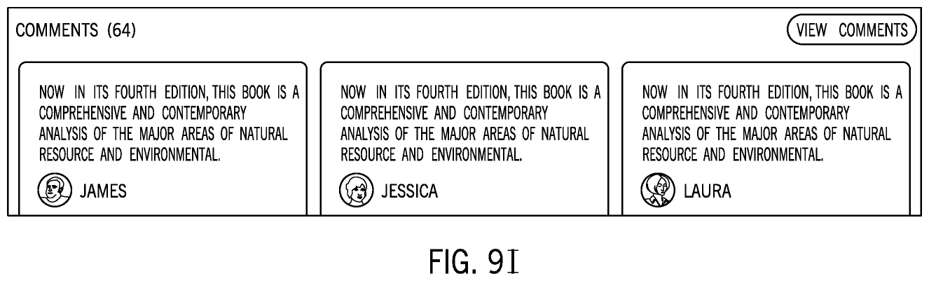

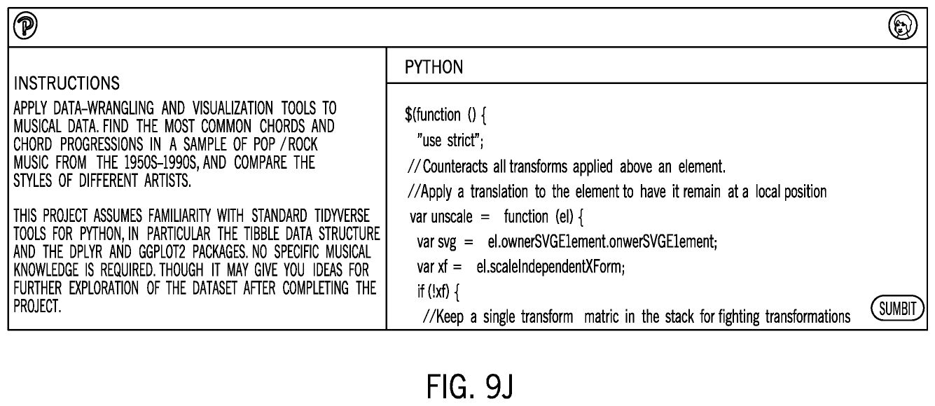

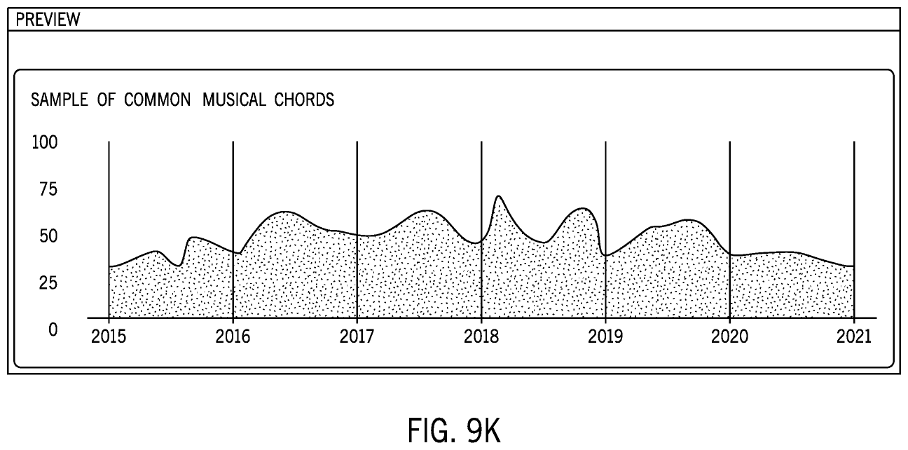

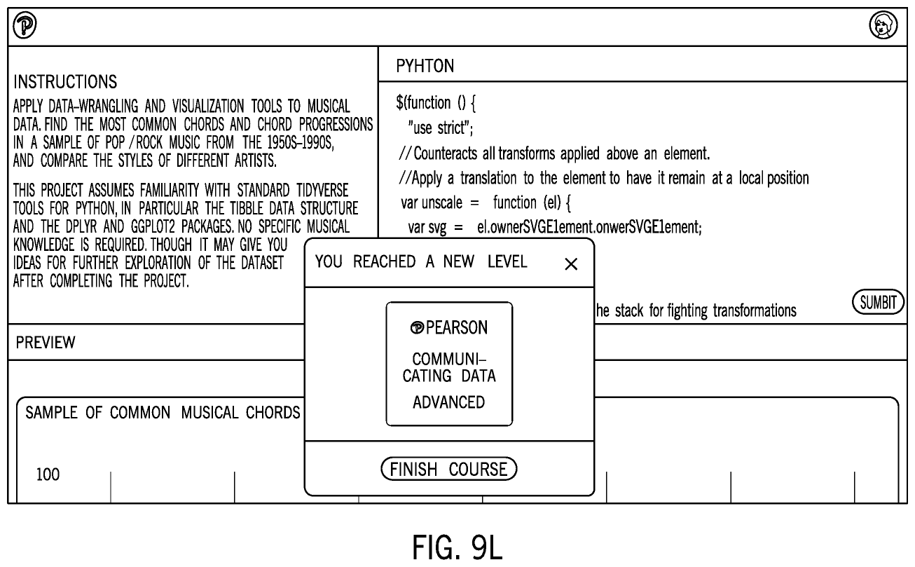

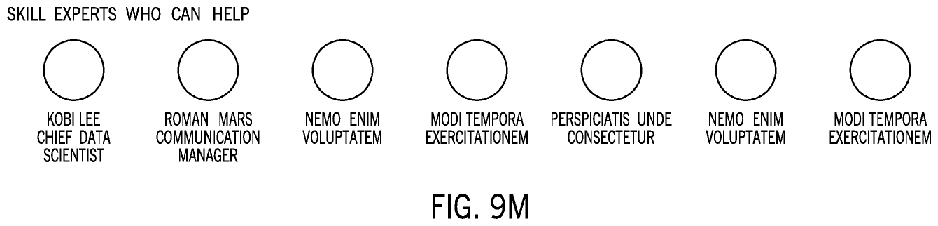

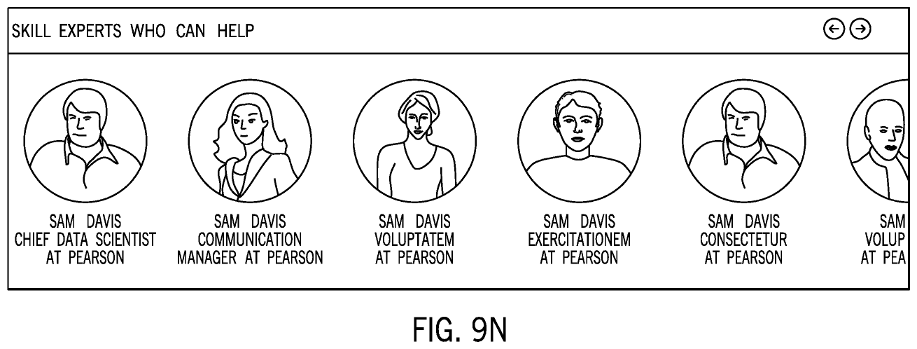

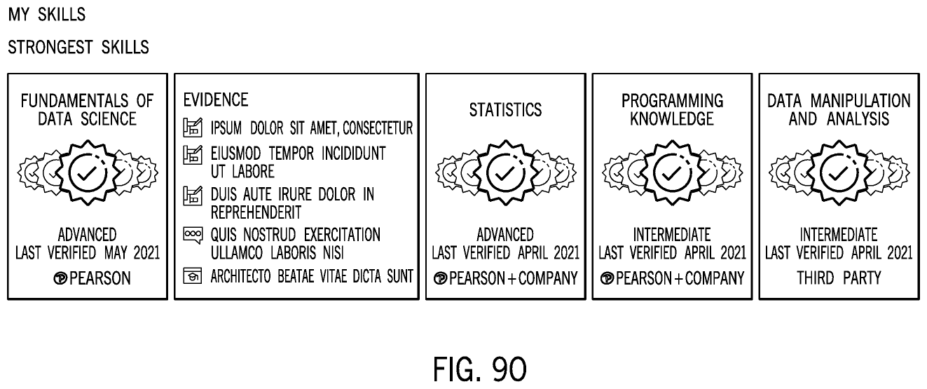

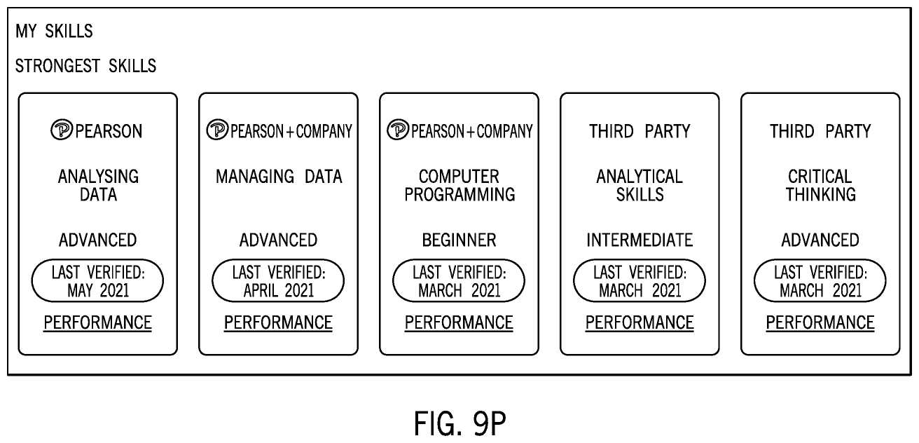

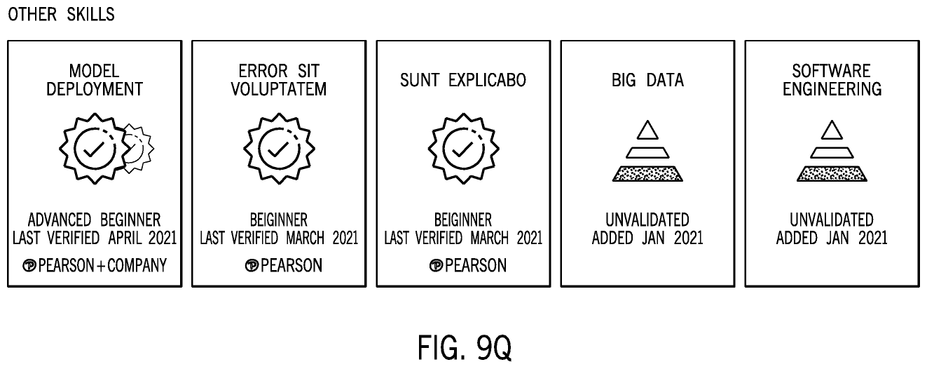

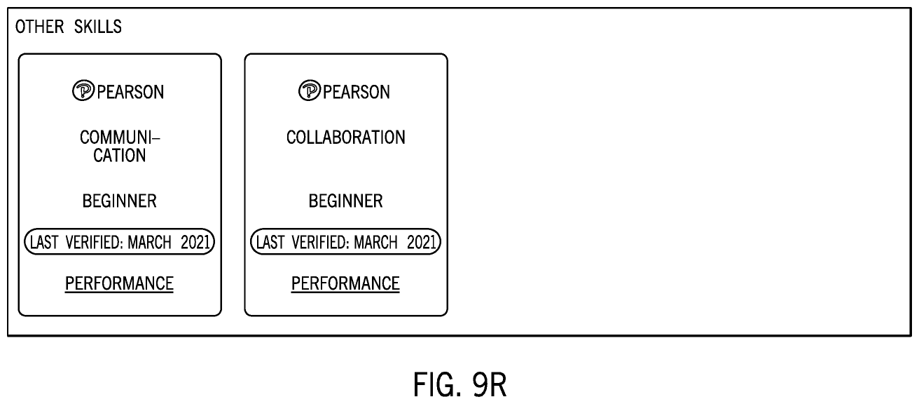

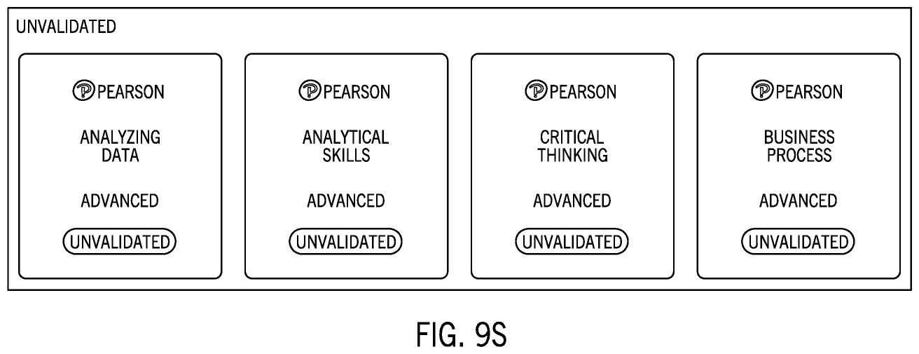

Turning now to FIGS. 9A-9D, the disclosed system may identify, select, and display various information relating to a user's profile. Whereas the GUI experience described above is focused more on a mobile optimized experience, several of these examples are meant to reflect a desktop web experience to better understand the flow of the disclosed embodiments. However, it should be noted that these example embodiments are non-limiting, and any environment, such as mobile or desktop environments, may be used to accomplish the method steps described herein.

The disclosed system may select data associated in data store 110 with the user, possibly by using authentication information to identify the correct user profile. Once this user profile has been identified in data store 110, the disclosed system may generate a GUI such as that seen in FIGS. 9A-9D and transmit this GUI to the client device 106 for display. In the non-limiting example embodiments seen in FIGS. 9A-9D, the system has selected, and displayed the additional data associated with the user profile, including the user's name, current role, and details of the user's current role, additional personal data, such as the user's interests, the user's current role or skill level, a spider graphic, as described above, showing a visual representation of the user's current skills and how they interrelate to demonstrate an overall visual representation of the user's skills.

As seen in FIGS. 9A-9D, the user may select, from the GUI additional career opportunities, thereby allowing and assisting the user visualizing various ways in which their career could progress. For example, in some embodiments, the user may start at a junior level, then visualize their progress to a mid-level, and then a senior level. In some additional embodiments, the user may also identify and explore additional adjacent careers, which the user may want to pursue, and further instruct the user in how their current skillset, as identified by the disclosed system may translate their current career path to an adjacent career path, based on the skills and experience data associated with the users profile account in data store 110.

In the example embodiments in FIGS. 9A-9D, the user may be a data engineer, but wants to access additional related adjacent careers, such as a data scientist. Using one or more GUI components on the generated GUI (e.g., a dropdown menu) and possibly identified within data store 110 as an adjacent career option, the user may select a related adjacent career, such as data scientist. In response to this selection, the disclosed system may analyze the user's current career and selected potential career, and update the spider graphic to include an additional line around the graph, and an associated explanation informing the user that if they were to improve some of their existing skills, the user may be able to transition into the selected adjacent career, such as a data scientist, and could be confident in applying for jobs in that area. The generated GUI may therefore identify and display new skills that the user would need to acquire in order to be successful in the selected adjacent career.

As seen in FIG. 9B, the disclosed system may also analyze and display advances in the user's current skill set. As a non-limiting example in FIG. 9B, after completing the non-limiting example Python challenge described in more detail above, the disclosed system may recalculate the user's current skill set and generate and/or update the GUI to reflect advances in the user's skills. In the non-limiting example embodiment in FIG. 9B, the disclosed system has analyzed the user's skill data in data store 110, analyzed this data, and identified advancements in the user's skillset, specifically that the user has advanced in Python skills. The disclosed system may then update the spider graph reflecting the advancements in the user's skillset, In the example GUI in FIG. 9B, the shaded section represents the user's advancements in Python, and the general advancements in the user's skillset.

Finally, as seen in FIGS. 9A and 9D, the disclosed system may generate, for display on the GUI, means to access or otherwise view the additional evidence that was provided by the user and stored in data store 110. In FIGS. 9A and 9D, the user may access the additional evidence using the GUI, possibly in association with the spider graphic, as seen in these figures.

Turning now to FIGS. 9E and 9F, the disclosed embodiments may include a “My Learning” section for the user within the GUIs provided for the user to explore their user profile, including additional evidence, such as challenges, experiences, projects, etc. as disclosed above, as well as potential skill-building projects and/or learning modules available to the user to improve their profile. In some embodiments, the disclosed system may include a library of projects and/or learning material, stored in the data store 110 for the system, and the projects and/or learning modules may be stored within this library.

In some embodiments, the projects and/or learning modules may be associated, within the disclosed system, with specific skills, projects, employment verticals, and the like. Thus, as a non-limiting example, in some embodiments, the disclosed system may detect the adjacent career described above, as selected by the user, and further identify all associated skills. The disclosed system may then identify projects and/or courses related to these skills or the associated selected career and offer these projects and/or courses as part of the “My Learning” portion of the disclosed embodiments.

To provide users with recommended projects and/or learning courses relevant to their skill set or their desired potential career, server 112 may analyze the data stored in association with the user profile, such as the user's current career, skills, projects, and the like, and generate a GUI, as seen in FIGS. 9E and 9F, comprising groupings of the relevant projects and/or learning courses. However, as demonstrated in FIGS. 9E-9F, the user would not be limited to projects and courses that were relevant to their current skillset, career, or potential career, but the GUI may further include links to explore other learning paths or careers.

In the embodiments shown in FIGS. 9E and 9F, the groupings of the projects and/or courses may be according to the users desired use of the projects and/or courses. Thus, in the non-limiting examples in FIGS. 9E and 9F, the projects and/or courses may be organized under headings, such as “Learning to grow in my current role,” “Learning to improve your current job,” Learning to move into a new role,” and “Learning to be a senior.”

In some embodiments, the disclosed system may identify the name and a short summary for each project and/or course. When generating the “My Learning” GUI, server 112 may therefore identify the name and description for the course and include these within the GUI. The GUI may further include links (e.g., the “View” button, or “See details” link in FIGS. 9E and 9F) to a full description and the details needed for accessing and taking the course, and/or starting the project, as described in more detail below.

As seen in FIGS. 9E and 9F, some embodiments may include a label identifying the provider of a course or project. As a non-limiting example, several of the courses in FIGS. 9E and 9F are provided by Pearson Education, and at least one project is provided by third party content. Also, in these examples, some embodiments may include pillboxes or other labels, such as a “Project” or a “Course,” emphasizing to the user that there are different ways for the user to learn and different ways that the user may show that they have learned, and what they have learned.

These varied formats provide flexibility to different users to emphasize their strengths. So, for example, one user may complete a course, completing any assignments and exams, while another user may submit a project that the user gets at work, or on their own time. This flexibility allows all users to continue building their portfolio, creating even greater strength to users, showing now only several years of experience, for example, but also the courses and projects completed by the user.

Turning now to FIGS. 9G-9K, upon the user selecting a project or learning course from the displayed GUI, as seen in FIGS. 9E and 9F, the selection input may be transmitted through network 120 to server 112. The disclosed system may then select a plurality of content associated with the selected project or course, from a content data library stored in data store 110 or elsewhere within the disclosed system. The disclosed system may then generate a GUI comprising the content selected and assembled from the content data library, and showing the makeup of the course, as demonstrated in FIGS. 9G-91. This GUI may then be transmitted through network 120 to the user's client device 106 for display, in order to present the user with the content for the selected course.

As a non-limiting example, in response to selecting the “View” button within the summary of the “Communicating Data” course, the disclosed system may transmit a request to server 112, which may select and assemble the content data, from the content data library, for the Communicating Data course, and generate a GUI including the content shown in FIGS. 9G-91, which demonstrate how the user may start the course (e.g., using the “Start Course” button in FIG. 9G), the makeup of the course, etc. As seen in FIG. 9G, the content for this example course, possibly pulled from the content data library, may include the name of the course and a short description, as well as a GUI component to bookmark the course, represented by the “Bookmark” button.

Turning now to FIG. 9H, the course content may also include a biography and/or professional profile for the instructor of the course, as well as the central content for course instruction. In some embodiments, such as that seen in FIG. 9H, the course content may be divided into chapters, providing greater convenience for the user, and allowing them to review the chapters according to their schedule.

FIG. 9I demonstrates user comments as an additional example of resources available to the user to improve their skills while taking the course. These comments may be provided by additional users, possibly by a dashboard GUI for their own GUI accounts related to the class (not shown), which receives user input from the user identified as relevant to the course, transmits the comments through the network 120, as a non-limiting example, and stores the comments in association with the course. As subsequent users access the course content, these comments may be displayed as demonstrated in FIG. 9I.

In some embodiments, such as those demonstrated in FIGS. 9J and 9K, the course content may include an additional valuable module: learning by doing. In the non-limiting example embodiment in FIGS. 9J and 9K, a user may be provided instructions for a mini project. For example, in FIG. 9J, the user is provided an integrated development environment, allowing the user to enter code according to the provided instructions. The result and/or output of the coding may be displayed, responsive to the user's input code, in FIG. 9K in the form of a graph. This represents a significant improvement over course content in the prior art, which includes only reading, watching videos, and the like vs. applied learning to learn a marketable skill, as shown in FIGS. 9J and 9K.

In some embodiments, the completion of elements of the course, or in some embodiments, the course itself, may propel the user to a higher skills level than previously reached. In the non-limiting example in FIG. 9L, upon completion of identified portions of the course content (e.g., completing the coding challenge seen in FIGS. 9J and 9K), the disclosed system may compare the completed portion of the course with a threshold defined within the system, possibly within data store 110. This threshold may be associated within the system with a framework defining various levels of skills. Upon passing this threshold, the system may be configured to generate a GUI, or update an existing GUI, as seen in FIG. 9L, to notify the user that they have reached a new level.

Turning now to FIGS. 9M and 9N, the disclosed system may provide users with access to skill experts who may assist each user. FIGS. 9M and 9N demonstrate, from a community perspective, experts in the field that the user has identified that they are interested in looking into, and further provides contact information allowing the user to reach out to these subject matter experts and potentially get advice or talk to them about their field.

To accomplish this, the disclosed system may store, possibly in data store 110, a plurality of subject matter experts. These subject matter experts may be associated within the disclosed system with various fields of study, as well as contact information for getting in touch with the subject matter experts. When a user accesses the disclosed embodiments, the disclosed system may identify, within the stored user profile data, one or more skills, previous, current, or potential career fields, completed projects, and the like, associated with the user profile data. The disclosed system may then identify matching subject matter experts within the data store and generate a GUI or GUI component analogous to those seen in FIGS. 9M and 9N, and transmit these to the client device 106 for display.

Turning now to FIGS. 90-9S, the user profile within the disclosed embodiments may include one or more GUIs or GUI components configured to display to the user a breakdown of the skills associated with their user profile, possibly identified through an analysis of all skills data associated with the user account profile, described above. To accomplish this, the disclosed system may select the user account profile data for an authenticated user, analyze the data to identify additional data, and generate a GUI, such as, or possibly including all components demonstrated in FIGS. 90-9S, and transmit these to a user's client device 106 for display.

As non-limiting examples, this data may include user skills and show the skills that the user has. In other words, as seen in FIGS. 90-9S, the generated GUls may include a series of panels. Each panel may include the name of the skill associated, and a level associated with that skill (e.g., Beginner, Intermediate, Advanced). In some embodiments, such as that seen in FIG. 90, each skill associated with the user account profile may further be associated with the evidence of the skill, disclosed above.

In some embodiments, the skills data stored within the disclosed system in association with the user account profile may further be associated with a strength of the skills. In the non-limiting examples seen in FIGS. 90-9S, the user's skills may be grouped, and displayed within the GUI, according to the user's strongest skills (FIGS. 90-9P), a user's other skills (FIGS. 9Q-9R), and the user's unvalidated skills (FIGS. 9Q and 9S).

The distinction between validated and invalidated may be determined according to whether the skills data has been validated by a reliable source. As a non-limiting example, skills data identified within a third-party social media source (e.g., LinkedIn), may not provide evidence of the user's skills that they've validated vs. invalidated, and the hosting organization therefore has no way to verify the user's skills data. The disclosed system may therefore provide means for the user to validate each of the listed skills associated with their account profile.

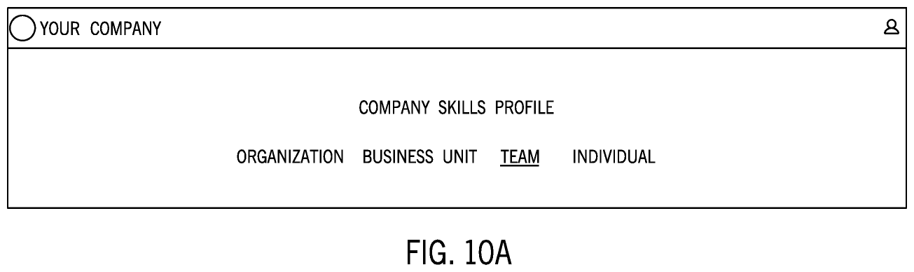

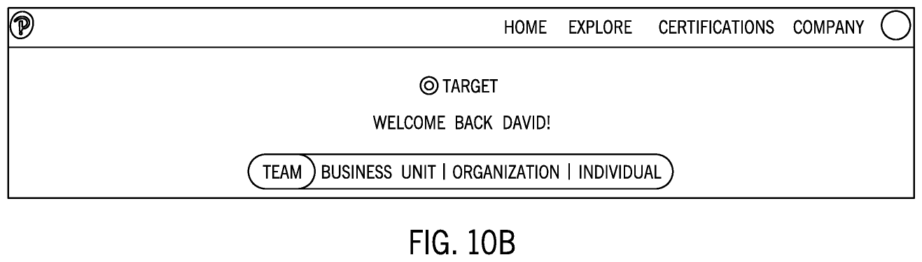

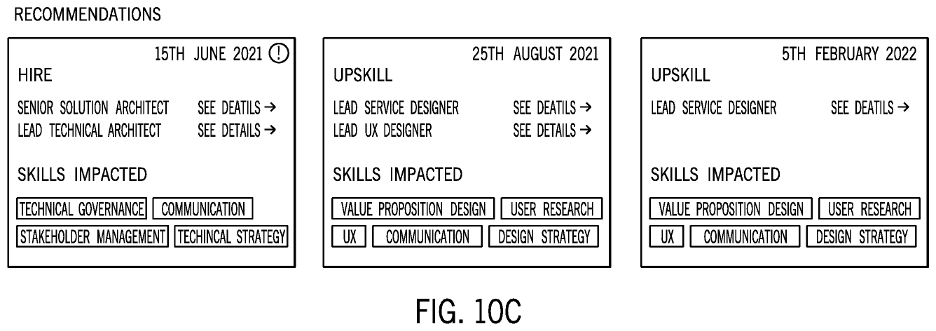

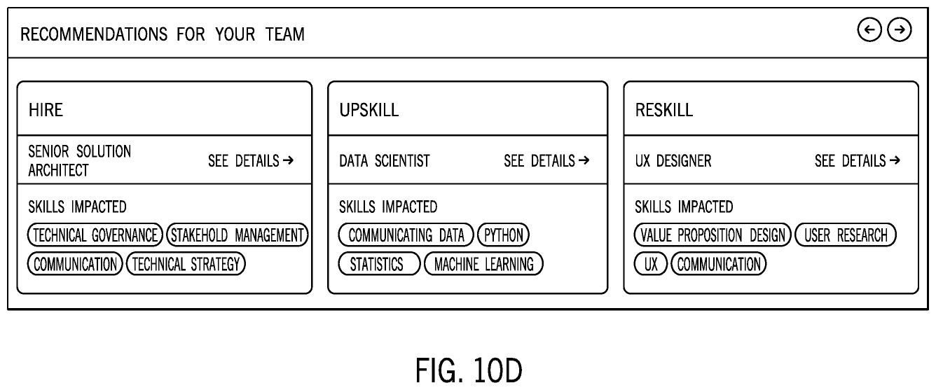

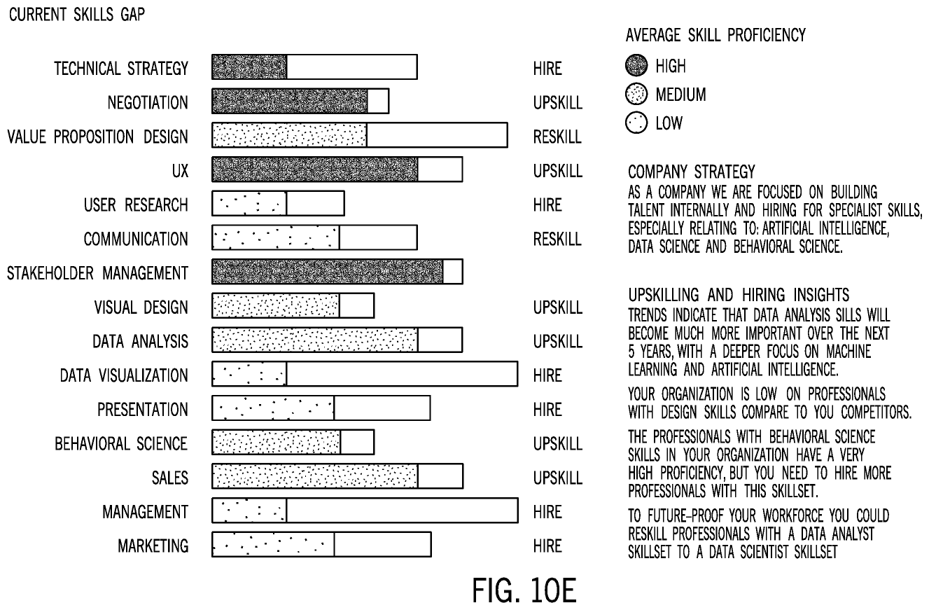

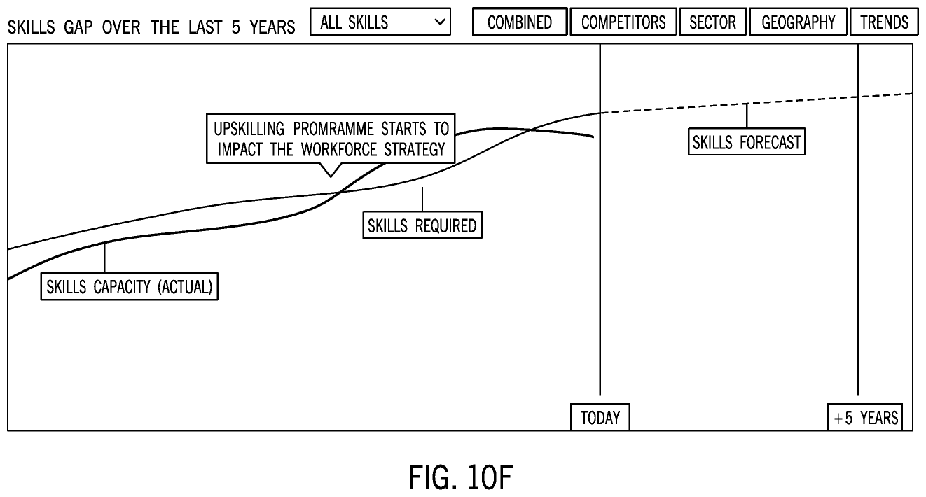

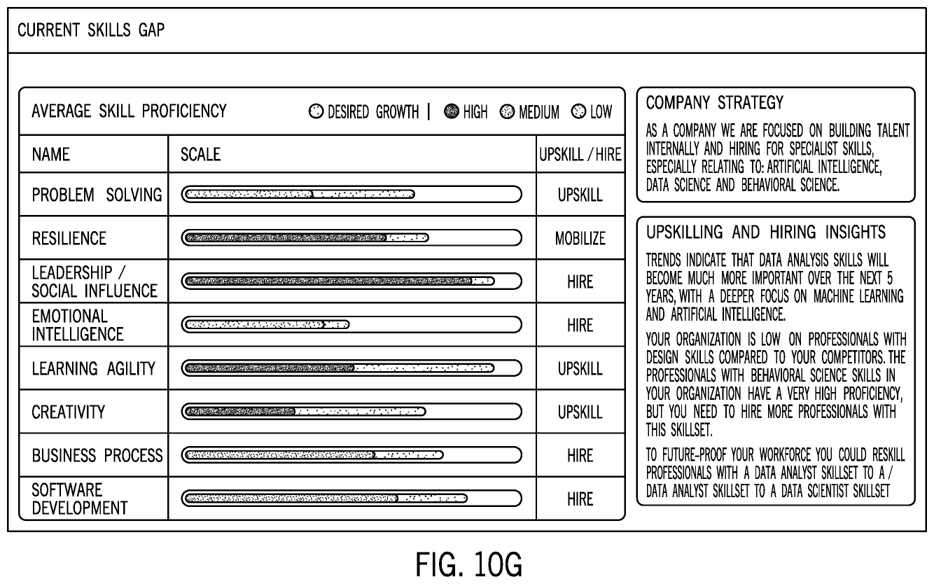

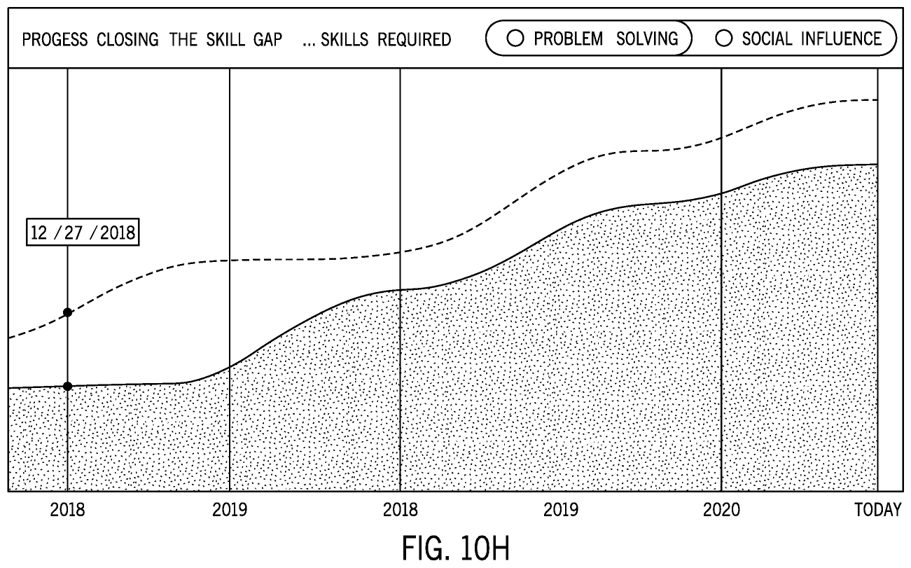

Turning now to FIG. 10A, the disclosed system may organize the available skills data, aggregated according to individual user account profiles, and analyze this data to provide benefit both to the company itself (e.g., a better trained workforce that can fill skills needs), as well as to the individual employees within the company (e.g., determining how to advance their career, as described in detail above). The company profiles described herein therefore provide an intersection between the employee wanting to improve their career and an employer who is looking to talent in its workforce to fill skills gaps.

FIG. 10A demonstrates a general company skills profile, and FIG. 10B demonstrates a non-limiting example involving a specific user (“David”) accessing the disclosed system on behalf of a specific company (“Target”). IN this example, the disclosed system may authenticate a user, identify, possibly within the user account profile, a company associated with the user and the user's role within a company. If authorized, the user may then access the skills data associated with the company, possibly stored in data store 110. The disclosed system may then generate one or more GUI components or GUIs to display the company data demonstrated in FIGS. 10A-10H, described in more detail below.

In FIGS. 10A-10B, the disclosed system may generate a GUI allowing the user to access analyzed skills data at several levels. In these non-limiting example embodiments, the user may access this skills data at the level of the organization, a business unit, a team, or individuals.

FIGS. 10A-10H demonstrate users' skillset across an entire workforce, such as an entire company, a team, a division, etc. In these non-limiting examples, the disclosed system may analyze the skills data at both the organization and individual level, and automatically generate recommendations based on the skill profiles of different users at the team, division, or organization levels, including analysis and recommendations for positions that the organization needs to fill, and the skillsets required of those positions. The recommendations may include recommendation to hire for certain positions, or recommendations to upskill current employees or other system users.

FIGS. 10A-10H further demonstrate that the disclosed system may determine that there are skill gaps within the organization and further identify connections between individuals and the company's need. For example, these figures demonstrate a display of the organization's “current skills gap,”, which displays broad skills gaps for the organization. Thus, depending on what the different skills are (e.g., problem solving, resilience, etc.), the disclosed system may automatically determine impactful that is for the organization, and the organization's current skill level for those demands. In the non-limiting examples in these figures, the disclosed system has automatically identified a skill gap for problem solving, but a low skill gap for leadership and social influence. The disclosed system may therefore identify the organization's current status, as well as where it may need to be to be successful.

The disclosed embodiments may further include historical progress for the organization in terms of closing the skill gap. In the demonstrated example embodiments, from the left, sometime in 2018, over time, the gap between the skill that's required and the skill that's available in the company is narrowing.

Continuing the non-limiting example user profile above, the user account profile for “Amina” may indicate, from her user account profile data, that she is looking to move into a data scientist role, which is in high demand. The system may therefore analyze both her individual data and the needs of the organization for the current user David. The system may therefore generate a GUI, displayed on David's client device, 106, letting David know that, rather than trying to go find an external hire, that Amina's profile indicates that she is internal and has a high percentage of the skills that the organization needs, so rather than hiring externally, David should encourage Anima to use the resources available to upskill, learn a few new things, and fill the necessary role.

The calculations made by the disclosed embodiments may be accomplished using a framework, including a reference skill graph, and/or knowledge taxonomy, used to determine various skills and map the relationships and associations of those skills with various individual user account profiles. This reference skill and/or knowledge taxonomy may further be configured to translate different taxonomies available from third party taxonomies into a centralized and standardized reference skill and/or knowledge taxonomy. A non-limiting example of such a reference skill or knowledge taxonomy may include a soft skills taxonomy.

The reference skills and/or knowledge taxonomy may include a taxonomy of different kinds of skills, levels of those different kinds of skills, and the like. As a non-limiting example, this framework may include a Global Scale of Skills (GSS), analogous to Pearson's Global Scale of English (GSE), which uses a series of tasks, or “can do” statements, to determine a predefined level of skill for a particular user. Similarly, the disclosed embodiments may include a series of tasks and/or associated skills, used to determine a scale of experience and skill sets that define a user's skill level according to experience and/or learning.

The second product opportunity addresses the role of higher education in the product opportunity space and attempts to determine whether higher education institutions could provide credit for learning done through professional projects done at work. Some of the disclosed embodiments in the second product opportunity may include various approaches to determine the role of higher education Institutions by providing, first, “bite sized” university content, and second, real degree credit.

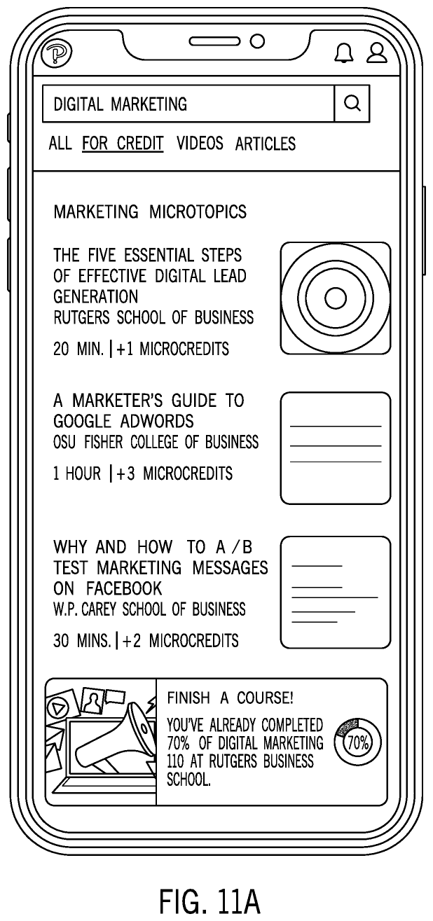

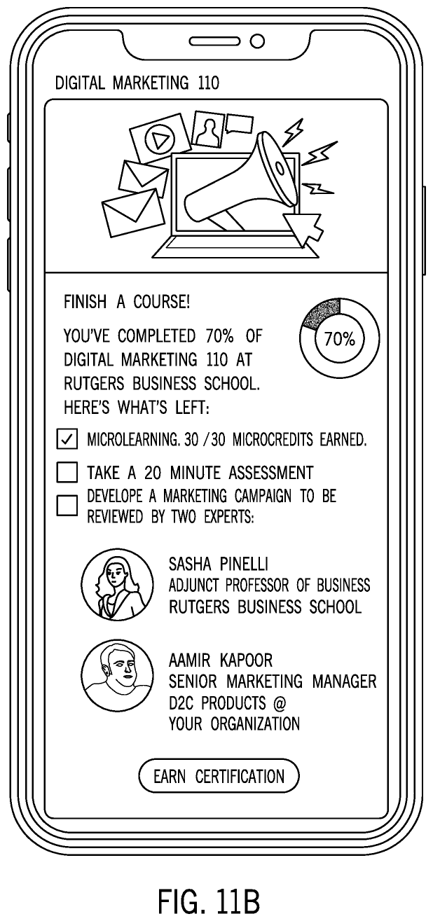

Turning now to FIG. 11A, server 112 may select content from a content database of university content, and generate a GUI including the university content, which is then sent to the user's client device 106 for display. The “bite sized” university content seen in FIG. 11A may include content that employees would have access to in the context of their work, which may then be made available to people, allowing them to access this content outside of the context of their own employer. In other words, universities would become a content producer in the context of the disclosed embodiments, and could provide consumable content on a digital device directly to students in form of lectures and classes, etc.

Turning now to FIG. 11B, server 112 may select content from a content database of university content, and generate a GUI including the university content, which is then sent to the user's client device 106 for display. FIG. 11B demonstrates a high value opportunity, allowing universities to offer real university credit for learning done at the user's place of employment or as a personal project. The non-limiting example embodiments represented in FIG. 11B allow a user to consumed content from the content library during the user's employment and identify the projects that the user has worked on or completed.

These projects may be cross referenced or otherwise tagged within the disclosed system with one or more skills at a particular level, and the disclosed system may determine, based on the cross-referenced skills, a percentage completed that could be applied to university credit for the work completed. As a non-limiting example, the disclosed system may determine that a user has worked on specific projects, and an amount of work on those projects completed by the user. The system may then analyze the user's account portfolio at all data related to projects worked on or completed by the user, and determine credits that the skills associated with those projects may be applied towards (e.g., completing a digital marketing course, completing 70% of a micro-master's degree in Finance, etc.).

Thus, in FIG. 11B, the user may complete learning at work, through a service provider's (e.g., Pearson Education) learning experiences, either through content the user has consumed, such as videos and Assessments, or through working on a project. As seen in FIG. 11B, the disclosed system may generate, for display on the user's client device 106, a notification alerting the user to their progress, or next steps (e.g., taking an assessment to demonstrate their progress, etc.). The notification may further instruct the user to complete various steps, such as taking a 20-minute assessment and do a small project reviewed by subject matter experts, to complete the remaining 30% to get this credit, which will then earn the user their certificate.

In some embodiments, the third and fourth product opportunities may also be combined, providing a direct to consumer (D2C) experience, allowing a user to try to learn and acquire new skills, thereby better defining the end user experience.

In some embodiments, the third product opportunity may create a platform where users may share their own content, share their own content playlists and provide and/or create communities formed where learners gather together around particular knowledge areas. The disclosed system may therefor create this third product area around discovery, curation, and sharing of learning content. The content created in the third product opportunity may include anything from a user taking a full course to providing a link to an article on a particular medium (e.g., “how to be a better UX designer”).

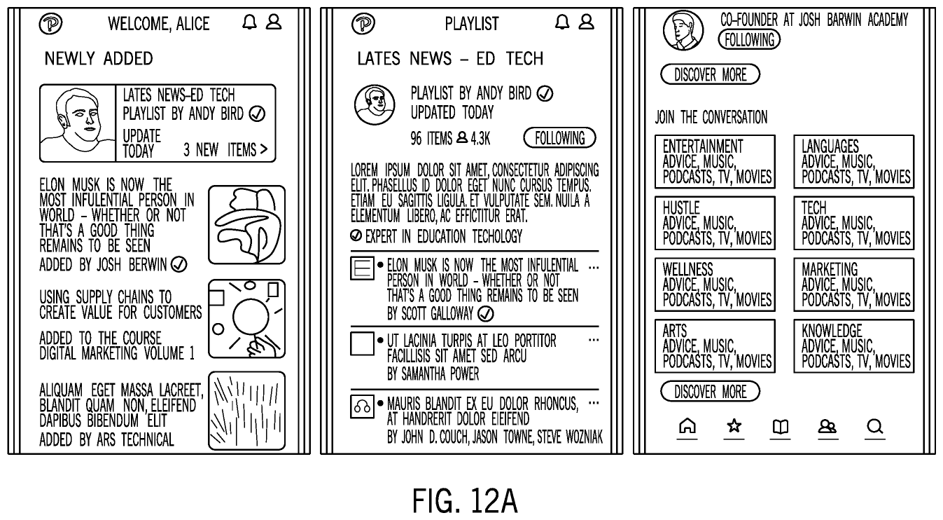

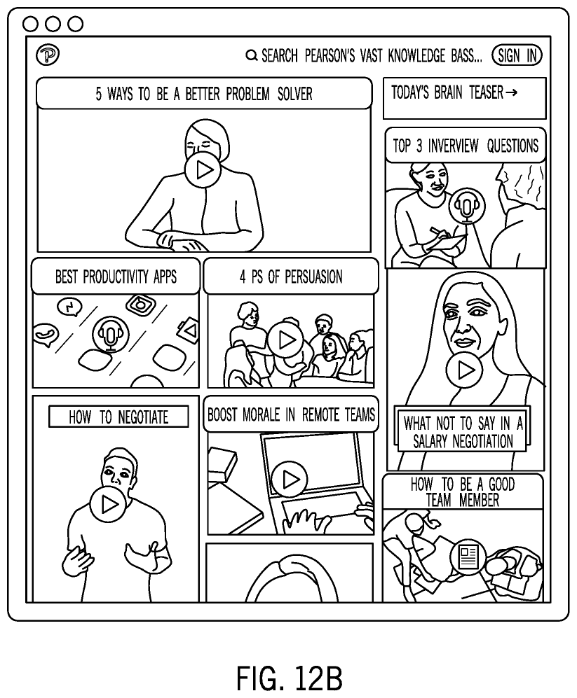

FIGS. 12A and 12B demonstrate non-limiting example embodiments of GUIs generated by the disclosed system, which may provide means for users to access discovery and curation of learning content. As non-limiting examples, the disclosed embodiments may include news sources, but these news sources may be focused specifically on work related or skill related topics, providing additional resources for improving the skills that a user may be trying to acquire. Thus, in various situations within a user's life experience, rather than providing a general search engine search, the disclosed embodiments may provide specialized search engine results.

These specialized search engine results may be accomplished using one or more discovery software modules within the disclosed system. These discovery software modules may provide the specialized search engine results through this application by providing validated content, or content with high ratings or expert ratings, etc. (e.g., 5 star ratings), allowing users to search and discover content specific to the topics that are of greatest interest or relevance. The results of these searches may be validated, such as validated articles or videos, helping users to complete projects or other assignments.

Building on the discovery-based software modules in the disclosed system above, the disclosed system may further include the ability for the user to curate the discovered content by adding it to a “playlist,” so to speak, or in the case of the user's interest, the disclosed system may receive from the user, input identifying different skill areas or topics that the user is interested in so that the application may search the relevant databases, looking for new content as it is made available. Through this curation, the user may then find, more easily over time, things that are better aligned with the user's interests in their career or other paths that they may be pursuing.

Machine learning may be applied to the disclosed embodiments, so that the more data that is aggregated by the system from users reading articles, watching videos, etc. as they search, and as they eventually take courses, take challenges, and the like, that the system may learn from those things serving up subsequent content to each individual.

The disclosed system may further provide software modules configured to allow users to connect with other users whose user account profiles indicate that these users have similar career goals, or are otherwise on a similar journey (e.g., trying to become a data scientist). The disclosed system may therefore identify similar characteristics and consumed content associated with user account profiles to match up individual users and groups who are looking for very similar things over time. Similarly, the disclosed system may identify users that are further ahead of other users in their particular journey or whatever their career goal might be. This product puts you in touch with those types of people so that the user can learn from them as well. That's the general idea.

The fourth product opportunity may include the disclosed system determining the role that an organization (e.g., Pearson) may play in creating premium consumer grade content similar to the quality of available online masterclasses and providing really high quality learning content.

Specifically, in the context of the fourth product opportunity, the disclosed system may be used to create high quality interactive experiences for users. These high-quality interactive experiences may be unique, but do not necessarily have to be. As noted above, the content provided by the disclosed system, possibly within data store 110, or available through third party channels, may include a masterclass. However, the disclosed embodiments may provide improvements over such classes known in the prior art, in that they may go beyond simply watching high quality videos or other content, but instead provide interactive experiences that accompany such content. Also just as high quality as what you would get through a master class which, for example, may be associated with soft skills assessment work, providing a high quality content experience.

As a non-limiting example, courses for teaching soft skills like leadership and communication may be harder to teach and measure, but may be improved through an interactive video, in which the user may be provided a narrative, and at certain points in the narrative, may be presented with choices on how to proceed.

The user may provide user input, such as clicking on their choice of how the narrative should proceed and experience the consequence of that choice within the interactive video to determine whether the choice was a good choice or a bad choice. The disclosed embodiments may include this type of interactive experience, thereby creating something a learning experience standpoint around communication or leadership, where it's a safe environment in which the user watches a video and is presented with a decision. When the decision is made, the video may continue along one of those paths and explains here's the outcome or here's what happens next.

Using this type of format and software modules within the disclosed system, testing soft skills could be done through simulation of some sort.

The fifth product opportunity may include a determination of how the organization may use data to enable the first product opportunity, and may be more of a way of working than an actual deliverable, per se.

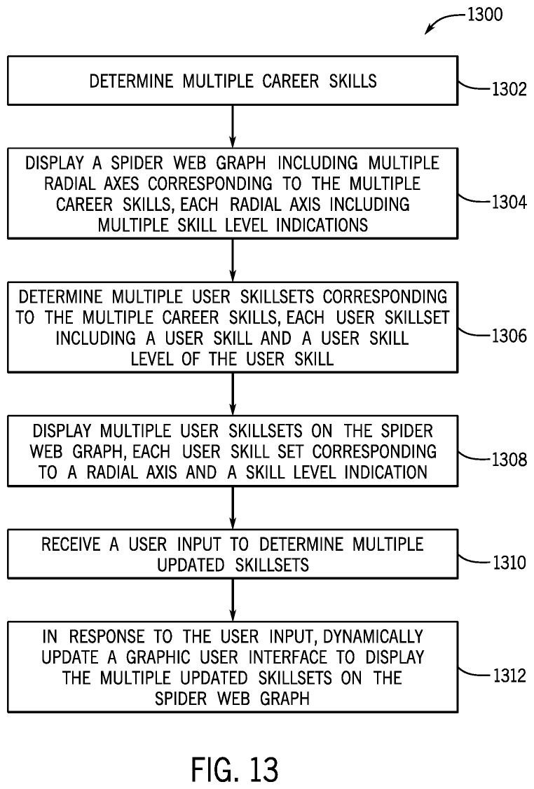

FIG. 13 illustrates a non-limiting example of a flowchart describing an example method and technique for user skill identification on a graphical user interface (GUI), in accordance with various aspects of the technique described in this disclosure. The flowchart of FIG. 13 utilizes various GUI screens that are described below with reference to FIGS. 9A-9D. In some examples, the process 1300 may be carried out by the server(s) 102 and/or the client device(s) 106 illustrated in FIG. 1, e.g., employing circuitry and/or software configured according to the block diagram illustrated in FIG. 2. In some examples, the process 1300 may be carried out by any suitable apparatus or means for carrying out the functions or algorithm described below. In some examples, any systems and/or GUI screens are used to implement the flowchart 1300. Additionally, although the blocks of the flowchart 1300 are presented in a sequential manner, in some examples, one or more of the blocks may be performed in a different order than presented, in parallel with another block, or bypassed.

At block 1302, a server (e.g., one or more of the server(s) 102, also referred to as the server 102) determines multiple career skills. Referring to FIG. 9B, in advance of or as part of block 1302, the server 102 can generate, for display on a client device for a user 902, a graphical user interface (GUI) 900. In an illustrative and non-limiting example, the GUI 900 can include a GUI screen 900, as shown in FIGS. 9A-9D. Referring back to FIGS. 9A-9D, an example GUI screen 900 includes a spider web graph 910, which is personalized and customized to the user 902 and illustrates career skills including a career skill 912. For example, a career skill 912 can indicate an ability to perform a task. For example, the career skill 912 can include a specific skill (e.g., Python, machine learning, Amazon web services), a branch of knowledge (e.g., statistics), an interpersonal skill (e.g., collaboration, communication, presentation skill), or any other suitable ability to perform a task (e.g., associated with a user career path, an employee position type, etc.).

In some examples, the server 102 can quantitatively indicate a career skill (e.g., the career skill 912) using a skill level indication (e.g., skill level indications 914, 916) associated with the career skill. In some examples, the skill level indication 914, 916 may indicate a level of competency of a user 902 to perform a task associated with the career skill 912. In a non-limiting scenario, the skill level indication 914, 916 can be one of five levels. However, it should be appreciated that the number of levels is not limited to five. The skill level indication 914, 916 can be one of any other suitable number of levels. In some examples, the skill level indication 914, 916 may include a numeral (e.g., 1, 2, 3, etc.), a letter (e.g., a, b, c, etc.), a word (novice, expert, etc.), a symbol, or any other suitable indication to indicate the level of competency of the user 902 for the career skill 912.

In some examples, the server 102 can determine one or more of the multiple career skills 912 based on a user career path 942 or a current role to. In some instances, a user career path 942 can be indicative of an occupation of the user. In a non-limiting scenario, the occupation may include a current occupation, a recent occupation, a future occupation for a job seeker, etc. In a non-limiting scenario, the server 102 can determine the multiple career skills 912 based on the user career path 942 (e.g., Data Engineer, Data Scientist, etc.). A data table (e.g., stored in a data store 110 or another accessible memory) may map each potential user career path 942 with a respective set of career skills 912. Thus, the server 102 can determine the multiple career skills 912 by accessing the data table using the user career path 942 as an input and receiving the multiple career skills 912 as an output. The particular career skills 912 may vary based on the career path 942. For example, a set of career skills 912 (e.g., Python, data structures, machine learning, etc.) to perform tasks as a data scientist 942 can be different from another set of career skills 912 (e.g., Photoshop, Illustrator, JavaScript, etc.) for a user interface designer. In some instances, the user career path 942 can be included in the user data stored in data store 110 shown in FIG. 1. In further instances, the user 902 can input the user career path 942 on a GUI to store the user career path 942 in data store 110. In other instances, the server 102 can determine the user career path 942 based on other user information. In even further instances, the server 102 can determine the user career path 942 based on information from a third-party database or information. In further examples, the server 102 can determine the multiple career skills 912 further based on an overall skill level 952 (e.g., junior, senior, lead, director, etc.). The overall skill level 952 of the career path 942 can indicate an overall ability (e.g., Junior, Senior, Lead, Director, etc.) to perform tasks for an employee position type (e.g., the career path 942). In some scenarios, different overall levels of the career path 942 can have different sets of the multiple career skills 912 to perform tasks.

At block 1304, the server 102 can display a spider web graph 910 on the GUI 900. The spider web graph 910 can include multiple radial axes 921 corresponding to the multiple career skills 912. Each radial axis 921 extends radially outward from a center 922. Although the spider web graph 910 includes eight radial axes 921 (only three of which are specifically labeled in FIG. 9B to simplify the diagram), in other examples, more or fewer radial axes 921 are included. As an example, in FIG. 9B, the server 102 can display, on the spider web graph 910, career skills 912 (e.g., Python, Statistics, Amazon Web Services, Presentation Skills, Collaboration, Communication, Machine Learning, Data Structures) to correspond to respective radial axes 921 of the spider web graph 910. In further examples, each radial axis of the spider web graph 910 can include multiple skill level indications 914, 916, 918, 920 (although the indications are only labeled on one radial axis 921 to simplify the diagram). In some examples, the server 102 can display the multiple skill level indications 914, 916, 918, 920 of each radial axis of the spider web graph 910 such that a low skill level indication 914 is closer to the center 922 of the spider web graph 910 than a high skill level indication 920. In further examples, the spider web graph 910 can include a polygon 924 with each radial axis of the polygon defined by a respective skill level indication of the multiple skill level indications 914, 916, 918, 920. In even further examples, the spider web graph 910 can include multiple polygons 924 corresponding to skill level indications of each career skill 912. For example, the lowest skill level indications (e.g., Level 1) of career skills 912 (e.g., Python, Statistics, Amazon Web Services, Presentation Skills, Collaboration, Communication, Machine Learning, Data Structures) are connected to form a polygon 924, which is the smallest polygon in the spider web graph 910. The next skill level indications (e.g., Level 2) of career skills 912 are connected to form another polygon. The highest skill level indications (e.g., Level 5) of career skills 912 are connected to form the biggest polygon 924 in the spider web graph 910. In a non-limiting scenario, the polygon can be a triangle shape to correspond to three career skills 912 to be displayed, a quadrangle shape to correspond to four career skills 912, or N-sided polygon to correspond to N career skills 912 to be displayed. In some examples, the server 102 can display the one or more polygons to show the same skill level indications of career skills 912 with dotted, straight, or curved lines. In further examples, the server 102 can display the multiple skill level indications of each career skill 912 with dots and a connection between two adjacent skill level indications of a career skill 912 with a line 926. Thus, the multiple skill level indications 914, 916, 918, 920 of a career skill 912 can be connected from the center 922 of the spider web graph 910 to the highest skill level indication 920 of the career skill 912 with a line 926 (which may be colinear or the same line as the corresponding radial axis 921).

At block 1306, the server 102 can determine multiple user skillsets corresponding to the multiple career skills. Each user skillset can include a user skill and a user skill level indication of the user skill. In some examples, a user skillset can be indicative of user's level of ability to perform a task associated with a user skill or a career skill. In further examples, a user skill of a user skillset can be one of the multiple career skills, and a user skill level indication of the user skill can be one of the multiple skill level indications of the career skill. For example, the user 902 can have a user skillset having a user skill (e.g., Python 912) and a user skill level indication (e.g., Level 4 (918)) of the user skill. Thus, the user has an ability to use Python 912 with Level 4 competency.

In a non-limiting example, the server 102 can determine each user skillset based on evidence associated with a respective user skillset. The evidence can include at least one of: a user input (e.g., a project, a certificate, a degree, a credential, a diploma, a license, a document, an experience, or any suitable indication that the user is able to perform a task related to the user skill 912), a completed challenge (e.g., a test shown in FIG. 7B or 7E, an assignment, a project, or any other suitable means to validate or determine a skill level indication 914, 916, 918 of the user skill 912), a completed project, a completed course (an e-book, a document, a video, a practice exam, a flashcard, a course, a lesson, etc.), or a third-party input. In some examples, the server 102 can dynamically update the user skill level indication in a user skillset based on updated evidence. In some examples, the dynamically updating the user skill level indication can indicate that the server 102 can update the GUI user skill level indication in real-time or near real-time based on the updated evidence (e.g., instantaneously or within a few or several seconds). For example, the user may upload a programming certificate related to Python. Then, the server 102 can dynamically determine that the user has an advanced ability (skill level 916) to utilize Python 912 and update the user skill level indication of Python to Level 5. In some instances, the determination of the user skill level indication of the user skillset 918 based on the user input can be tentative. The server 102 can provide one or more challenges to verify the user skill level indication 918 associated with the user skill 912. In some examples, the user 902 does not have any data (e.g., experience, certificate, challenge passage, etc.) to show a user skill level indication of a user skill. Then, the server 102 can set the user skill level indication for the user skill as Level 1 or Beginner 928. In some examples, each type of evidence for a skill may be associated with a particular skill level value (e.g., via a lookup table mapping evidence to values). The sum of the values associated with evidence for a particular skill on a radial axis 921 may correspond to the user skill level indication on the axis 921 for that skill. In other examples, other techniques or formulas are used to quantify a user skill level indication for a particular skill based on evidence

At block 1308, the server 102 can display multiple user skillsets on the spider web graph 910. Each user skillset can correspond to a respective radial axis of the multiple radial axes and a skill level indication of the multiple level indications associated with the respective radial axis. For example, the spider web graph 910 can show a career skill (e.g., Python) and 5 levels 914, 916, 918, 920 of the career skill 912. The server 102 can display a user skillset to correspond to the career skill 912 (e.g., Python) and a skill level indication (Level 4 (918)) of the career skill (e.g., with a dot, a symbol, or any other suitable mark indicative of the user skillset). Similarly, the server 102 can display other user skillsets corresponding to other career skills on the spider web graph 910. In some examples, the server can display the multiple user skillsets 912 as a polygon 930 with each radial axis of the polygon 930 defined by a respective user skillset of the multiple user skillsets. For example, the server 102 can display Level 4 (918) (i.e., a user skill level indication of a user skillset) of Python (i.e., a user skill of the user skillset), Level 4 of Statistics, Level 4 of Amazon Web Services, Level 4 of Presentation Skills, Level 3 of Collaboration, Level 4 of Communication, Level 3 of Machine Learning, and Level 3 of Data Structures as a polygon 930 on the spider web graph 910. Each user skillset 918 can correspond to a respective radial axis of the polygon 930. In further examples, a first user skillset of the multiple user skillsets can correspond to a first radial axis of the polygon 930. A second user skillset of the multiple user skillsets can correspond to a second radial axis of the polygon 930. The second radial axis can be adjacent to the first radial axis. The server 102 can connect the first radial axis of the polygon 930 to the second axis of the polygon 930. The connection can be a line, a dotted line, a curve, or any other suitable indications to show the connection between the two adjacent axes of the polygon 930. In further examples, the server 102 can receive another user input on a user skillset of the multiple user skillsets. In response to the user input, the server 102 can display the evidence 962 associated with the user skillset as shown in FIG. 9D. In even further examples, the server 102 can color the polygon 930 with a different color from the other area in the GUI 900.

At block 1310, the server 102 can receive a user input to determine multiple updated skillsets. In some examples, the user input can include an overall skill level 954 for an employee position type or a user career path. For example, the server 102 can display overall skill levels 952, 954 (e.g., Junior, Senior, Lead, Director, etc.) on the GUI 900. The server 102 can show the current overall skill level 952 (e.g., Junior) of the user for the current user career path 942 or employee position (e.g., Data Scientist) by highlighting the current overall skill level 952 with a different text color, a different background color, a circle, or any other suitable indication to show the current overall skill level 952 of the current career path 942. In some scenarios, the user 902 can select an overall skill level 954 (e.g., Senior, Lead, Director, etc.) other than the current overall skill level 952 (e.g., Junior) of the user 902 for the position 942 (e.g., Data Scientist). In further scenarios, the server 102 can display overall skill levels 952, 954 using a dropdown menu or any other suitable means to show the overall skill levels 952, 954. In some instances, the server 102 can determine the multiple updated skillsets, each including an updated career skill and an updated skill level indication of the updated career skill based on the selected overall skill level 952 for the employee position type or the current career path 942. For example, the server 102 can determine Level 3 (916) (i.e., an updated skill level indication of an updated skillset) of Python (i.e., a career skill of the user skillset), Level 4 of Statistics, Level 4 of Amazon Web Services, Level 4 of Presentation Skills, Level 3 of Collaboration, Level 5 of Communication, Level 3 of Machine Learning, and Level 4 of Data Structures based on a user input (e.g., Senior). The updated skill level indications and updated career skills shown above are a mere example. Any other suitable career skills and level indications for an overall skill level 954 may be associated with the current career path 942.

In some scenarios, the server 102 can redetermine the multiple career skills 912 based on the selected overall skill level 954 because the selected overall skill level 952 for the user career path 942 (e.g., Data Scientist) can have different career skills than the multiple career skills 912 for the current overall skill level 952 for the user career path 942. Then, the server 102 can dynamically update the spider web graph based on the redetermined career skills. In some examples, the dynamically updating the spider web graph can indicate that the server 102 can update the spider web graph in real-time or near real-time based on the redetermined career skills. For example, the user 902 can have a current overall skill level 952 (e.g., Junior) and select an advanced overall skill level 954 (e.g., “Senior”) for the user career path (e.g., “Data Scientist”). If the advanced overall skill level 954 uses an additional career skill (e.g., Project Management Skills) to perform tasks as a senior data scientist, the server 102 can dynamically display an additional radial axis to correspond to the additional career skill with multiple skill level indications for the additional career skill on the spider web graph 910 in response to the user input 954. The server 102 can also indicate an updated skillset including the additional career skill with an updated skill level indication among the multiple skill level indications to sufficiently perform tasks for the career skill as the advanced overall skill level 954. For example, the server 102 can indicate Level 3 of Project Management Skills for the senior data scientist. Thus, the server 102 can determine multiple updated skillsets based on the user input (e.g., selected overall skill level).

In other examples, the user input can include a potential career path 944 as shown in FIG. 9C. For example, the server 102 can display one or more potential career paths 944. The server 102 can determine the one or more potential career paths 944 based on the user career path 942 such that the potential career paths 944 are related to the user career path 942. For example, if the user career path is a data scientist 942, the server can display a list of potential career paths 944 (e.g., machine learning engineer, machine learning scientist, application architect, enterprise architect, infrastructure architect, etc.) which are related to or adjacent to the user career path 942. The server 102 may store (e.g., in a datastore 110) a data table of related or adjacent career paths that is accessed (e.g., using the current career path 942) and provides as output the related or adjacent career paths. In some examples, the server 102 can show the potential career paths 944 using a dropdown menu or any other suitable means to show the potential career paths 944.

In some scenarios, the server 102 can redetermine the multiple career skills 912 based on the selected potential career path 944 because the potential career path 944 can have different career skills than the multiple career skills 912 for the user career path 942. Then, the server 102 can dynamically update the spider web graph 910 based on the redetermined career skills. For example, the user career path 942 can be a data scientist and select a machine learning engineer 944 as a potential career path. If the machine learning engineer 944 uses an additional career skill (e.g., Algorithms) to perform tasks as a machine learning engineer 944, the server 102 can dynamically display an additional radial axis to correspond to the additional career skill with multiple skill level indications for the additional career skill on the spider web graph 910 in response to the user input 944. The server 102 can also indicate an updated skillset including the additional career skill with an updated skill level indication among the multiple skill level indications to sufficiently perform tasks for the career skill as the machine learning engineer (i.e., the potential career path 944). For example, the server 102 can indicate Level 3 of Algorithms for the machine learning engineer. Thus, the server 102 can determine multiple updated skillsets based on the user input (e.g., selected potential career path).

At block 1312, in response to the user input, the server 102 can dynamically update the graphical user interface 900 to display the multiple updated skillsets on the spider web graph 910. The updated skill set may include, for example, an updated skill level indication 916 of a skill set associated with an existing radial axis 921, a new skill 912 of a skill set associated with an existing radial axis 921, both a new skill level indication 916 and new skill 912 associated with an existing radial axis 921, and/or both a new skill level indication 916 and new skill 912 associated with an new radial axis 921. In some examples, the dynamically updating the GUI can indicate that the server 102 can update the GUI in real-time or near real-time in response to the user input. Thus, when the server 102 receives the user input, the server 102 simultaneously or almost simultaneously update the GUI 900 to display the multiple updated skillsets on the spider web graph 910. As described at block 1310, the user input can be an overall skill level 954 for an employee position type or a potential career path 944. In some examples, the server 102 can simultaneously display the multiple user skillsets (e.g., including level 918) and the multiple updated skillsets (e.g., including skill level 916) on the spider web graph 910. In other examples, the updated skillsets may replace the previously displayed skillsets on the spider web graph 910. Each updated skillset can correspond to a respective radial axis of the multiple radial axes of the spider web graph 910 and an updated skill level indication 916 of the multiple skill level indications associated with the respective radial axis. In further examples, the server 102 can display the multiple updated skillsets as a polygon 932 with each vertex of the polygon defined by a respective updated skillset of the multiple updated skillsets. In even further examples, a first updated skillset (e.g., having skill level 916 or Level 3 of Python) of the multiple updated skillsets and correspond to a first vertex of the polygon 932 on a first radial axis of the graph 910. A second updated skillset (e.g., having level 934 or Level 4 of Data Structures) of the multiple updated skillsets can correspond to a second vertex of the polygon 932 on a second radial axis of the graph 910. The second level 934 can be a vertex on a second radial axis 921 adjacent to the first radial axis 921 having the first skill level 916. The first skill level 916 (or vertex) of the polygon 932 can be connected to the second level 934 (or vertex) of the polygon 932 using a dotted line, a curve, or any other suitable indications to show the connection (or edge) between the two adjacent vertexes (on two adjacent radial axes 921) of the polygon 932. Accordingly, the term polygon, as used herein, can include vertices or points connected by straight and/or curved edges. In even still further examples, the server 102 can color the polygon 932 with a different color from the other area in the GUI 900. In a non-limiting scenario, a skill level indication of a user skillset may be higher than an updated skill level indication of an updated skillset corresponding to the user skill set. Then, the server 102 can indicate that the user possesses an ability to perform task related to the career skill of the user skillset more than the skill level that an advanced overall skill level or a potential career path uses in connection to the career skill. The server 102 can show the indication with a different color, mark, symbol or any other suitable indication.

In the discussion of the process 1300, including with respect to blocks 1304 and 1308, the server 102 is described as displaying information (e.g., a spider web graph, a graphical user interface, skillsets, etc.). Such display by the server 102 may include the transmission of display data to a client device having a display screen (e.g., an LED screen, an OLED screen, plasma screen, or the like), where the client device, in response to receipt of the display data, displays the received display data. In other words, the server 102 displaying information may include the server 102 controlling a directly coupled display screen to display the information as well as (or alternatively) transmitting the information to cause another computing device to display the information.

Thus, the server 102 can provide a graphical user interface for a client device 106 that enables a user to dynamically (e.g., in real time or in near real time) visualize user skillsets that the user acquired and desirable skillsets with an advanced overall skill level (e.g., Senior, Lead, Director, etc.) or a potential career path related to the user career path. The graphical user interface 900, and underlying backend system, provides additional and improved functionality relative to other online or digital skills identification systems in that the graphical user interface 900 displays simplified and quantified user skill level indications of corresponding career skills. In addition, the graphical user interface 900 provides simplified and intuitive displays of user skillsets and updated skillsets, relative to other systems that provide cluttered, complex, less informative, and unintuitive displays of user skills. Thus, for example, the graphical user interface 900 (e.g., via the method 1300), is able to display more information, in a more intuitive manner, and with less area on a display screen, relative to other graphical user interfaces. In addition, the interactive and dynamic graphical user interface 900 improves the user interface on a client device by preventing the display of undesired or irrelevant career skills and dynamically providing the display of desired or relevant user skillsets and/or updated skillsets for an advanced overall skill level or a potential career path. At the same time, the display of desired or relevant user skillsets and/or updated skillsets reduces unnecessary battery use of the client device and the network resource usage by reducing access to the network and database (e.g., data store 110) in the server 102.

### FURTHER EXAMPLES HAVING A VARIETY OF FEATURES

The disclosure may be further understood by way of the following examples:

Example 1: A method, apparatus, and non-transitory computer-readable medium for user skill identification on a graphical user interface comprises: determining a plurality of career skills; displaying a spider web graph comprising a plurality of radial axes corresponding to the plurality of career skills, each radial axis of the plurality of radial axes comprising a plurality of skill level indications; determining a plurality of user skillsets corresponding to the plurality of career skills, each user skillset of the plurality of user skillsets comprising a career skill and a user skill level indication of the career skill; displaying the plurality of user skillsets on the spider web graph, each user skillset of the plurality of user skillsets corresponding to a respective radial axis of the plurality of radial axes and a skill level indication of the plurality of skill level indications associated with the respective radial axis; receiving a first user input to determine a plurality of updated skillsets; and in response to the first user input, dynamically updating the graphical user interface to display the plurality of updated skillsets on the spider web graph.

Example 2: The method, apparatus, and non-transitory computer-readable medium according to Example 1, wherein the dynamically updating the graphical user interface comprises: simultaneously displaying the plurality of user skillsets and the plurality of updated skillsets on the spider web graph, each updated skillset of the plurality of updated skillsets corresponding to a respective radial axis of the plurality of radial axes and an updated skill level indication of the plurality of skill level indications associated with the respective radial axis.

Example 3: The method, apparatus, and non-transitory computer-readable medium according to Example 1 or 2, wherein the displaying the plurality of user skillsets on the spider web graph comprises: displaying the plurality of user skillsets as a first polygon with each radial axis of the first polygon defined by a respective user skillset of the plurality of user skillsets.

Example 4: The method, apparatus, and non-transitory computer-readable medium according to any of Examples 1-3, wherein a first user skillset of the plurality of user skillsets corresponds to a first radial axis of the first polygon, wherein a second user skillset of the plurality of user skillsets corresponds to a second radial axis of the first polygon, the second radial axis being adjacent to the first radial axis, and wherein the first radial axis of the first polygon is connected to the second axis of the first polygon.

Example 5: The method, apparatus, and non-transitory computer-readable medium according to any of Examples 1-4, wherein the dynamically updating the graphical user interface comprises: displaying the plurality of updated skillsets as a second polygon with each radial axis of the second polygon defined by a respective updated skillset of the plurality of updated skillsets.

Example 6: The method, apparatus, and non-transitory computer-readable medium according to any of Examples 1-5, wherein a first updated skillset of the plurality of updated skillsets corresponds to a first radial axis of the second polygon, wherein a second updated skillset of the plurality of updated skillsets corresponds to a second radial axis of the second polygon, the second radial axis being adjacent to the first radial axis, and wherein the first radial axis of the second polygon is connected to the second axis of the second polygon.

Example 7: The method, apparatus, and non-transitory computer-readable medium according to any of Examples 1-6, wherein the spider web graph comprises a polygon with each radial axis of the polygon defined by a respective skill level indication of the plurality of skill level indications.

Example 8: The method, apparatus, and non-transitory computer-readable medium according to any of Examples 1-7, further comprising: displaying the plurality of skill level indications of each radial axis of the plurality of radial axes such that a low skill level indication of the plurality of skill level indications is closer to a center of the spider web graph than a high skill level indication of the plurality of skill level indications.

Example 9: The method, apparatus, and non-transitory computer-readable medium according to any of Examples 1-8, wherein the first user input comprises an overall skill level for an employee position type, and wherein the determining the plurality of updated skillsets comprises: determining the plurality of updated skillsets based on the overall skill level.

Example 10: The method, apparatus, and non-transitory computer-readable medium according to any of Examples 1-9, further comprising: determining a user career path, wherein the determining the plurality of career skills comprises: determining the plurality of career skills based on the user career path.

Example 11: The method, apparatus, and non-transitory computer-readable medium according to any of Examples 1-10, wherein the first user input comprises a potential career path, and the method further comprising: redetermining the plurality of career skills based on the potential career path; dynamically updating the spider web graph based on the redetermining the plurality of career skills; redetermining the plurality of user skillsets based on the redetermining the plurality of career skills; and dynamically updating the plurality of user skillsets on the spider web graph based on the redetermining the plurality of user skillsets.

Example 12: The method, apparatus, and non-transitory computer-readable medium according to any of Examples 1-11, wherein the determining the plurality of user skillsets comprises: determining each user skillset of the plurality of user skillsets based on evidence associated with a respective user skillset, the evidence comprising at least one of: a second user input, a completed challenge, a completed project, a completed course, or a third-party input.

Example 13: The method, apparatus, and non-transitory computer-readable medium according to any of Examples 1-12, further comprising: receiving a third user input on a user skillset of the plurality of user skillsets; and in response to the third user input, displaying the evidence associated with the user skillset.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method for user skill identification on a graphical user interface, the method comprising:
determining a plurality of career skills;
displaying a spider web graph comprising a plurality of radial axes corresponding to the plurality of career skills, each radial axis of the plurality of radial axes comprising a plurality of skill level indications;
determining a plurality of user skillsets corresponding to the plurality of career skills, each user skillset of the plurality of user skillsets comprising a career skill and a user skill level indication of the career skill;
displaying the plurality of user skillsets on the spider web graph, each user skillset of the plurality of user skillsets corresponding to a respective radial axis of the plurality of radial axes and a skill level indication of the plurality of skill level indications associated with the respective radial axis;
receiving a first user input to determine a plurality of updated skillsets; and
in response to the first user input, dynamically updating the graphical user interface to display the plurality of updated skillsets on the spider web graph.

2. The method of claim 1, wherein the dynamically updating the graphical user interface comprises:
simultaneously displaying the plurality of user skillsets and the plurality of updated skillsets on the spider web graph, each updated skillset of the plurality of updated skillsets corresponding to a respective radial axis of the plurality of radial axes and an updated skill level indication of the plurality of skill level indications associated with the respective radial axis.

3. The method of claim 1, wherein the displaying the plurality of user skillsets on the spider web graph comprises:
displaying the plurality of user skillsets as a first polygon with each radial axis of the first polygon defined by a respective user skillset of the plurality of user skillsets.

4. The method of claim 3, wherein a first user skillset of the plurality of user skillsets corresponds to a first radial axis of the first polygon,
wherein a second user skillset of the plurality of user skillsets corresponds to a second radial axis of the first polygon, the second radial axis being adjacent to the first radial axis, and
wherein the first radial axis of the first polygon is connected to the second radial axis of the first polygon.

5. The method of claim 3, wherein the dynamically updating the graphical user interface comprises:
displaying the plurality of updated skillsets as a second polygon with each radial axis of the second polygon defined by a respective updated skillset of the plurality of updated skillsets.

6. The method of claim 5, wherein a first updated skillset of the plurality of updated skillsets corresponds to a first radial axis of the second polygon,
wherein a second updated skillset of the plurality of updated skillsets corresponds to a second radial axis of the second polygon, the second radial axis being adjacent to the first radial axis, and
wherein the first radial axis of the second polygon is connected to the second axis of the second polygon.

7. The method of claim 1, wherein the spider web graph comprises a polygon with each radial axis of the polygon defined by a respective skill level indication of the plurality of skill level indications.

8. The method of claim 1, further comprising:
displaying the plurality of skill level indications of each radial axis of the plurality of radial axes such that a low skill level indication of the plurality of skill level indications is closer to a center of the spider web graph than a high skill level indication of the plurality of skill level indications.

9. The method of claim 1, wherein the first user input comprises an overall skill level for an employee position type, and
wherein the determining the plurality of updated skillsets comprises:
determining the plurality of updated skillsets based on the overall skill level.

10. The method of claim 1, further comprising:
determining a user career path,
wherein the determining the plurality of career skills comprises:
determining the plurality of career skills based on the user career path.

11. The method of claim 1, wherein the first user input comprises a potential career path, and
the method further comprising:
redetermining the plurality of career skills based on the potential career path;
dynamically updating the spider web graph based on the redetermining the plurality of career skills;
redetermining the plurality of user skillsets based on the redetermining the plurality of career skills; and
dynamically updating the plurality of user skillsets on the spider web graph based on the redetermining the plurality of user skillsets.

12. The method of claim 1, wherein the determining the plurality of user skillsets comprises:
determining each user skillset of the plurality of user skillsets based on evidence associated with a respective user skillset, the evidence comprising at least one of: a second user input, a completed challenge, a completed project, a completed course, or a third-party input.

13. The method of claim 12, further comprising:
receiving a third user input on a user skillset of the plurality of user skillsets; and
in response to the third user input, displaying the evidence associated with the user skillset.

14. A system for user skill identification on a graphical user interface, comprising:
a memory; and
a processor in communication with the memory, the processor configured to:
determine a plurality of career skills;
display a spider web graph comprising a plurality of radial axes corresponding to the plurality of career skills, each radial axis of the plurality of radial axes comprising a plurality of skill level indications;
determine a plurality of user skillsets corresponding to the plurality of career skills, each user skillset of the plurality of user skillsets comprising a career skill and a user skill level indication of the career skill;
display the plurality of user skillsets on the spider web graph, each user skillset of the plurality of user skillsets corresponding to a respective radial axis of the plurality of radial axes and a skill level indication of the plurality of skill level indications associated with the respective radial axis;
receive a first user input to determine a plurality of updated skillsets; and
in response to the first user input, dynamically update the graphical user interface to display the plurality of updated skillsets on the spider web graph.

15. The system of claim 14, wherein to dynamically update the graphical user interface, the processor is configured to:
simultaneously display the plurality of user skillsets and the plurality of updated skillsets on the spider web graph, each updated skillset of the plurality of updated skillsets corresponding to a respective radial axis of the plurality of radial axes and an updated skill level indication of the plurality of skill level indications associated with the respective radial axis.

16. The system of claim 14, wherein to display the plurality of user skillsets on the spider web graph, the processor is configured to:
display the plurality of user skillsets as a first polygon with each radial axis of the first polygon defined by a respective user skillset of the plurality of user skillsets.

17. The system of claim 16, wherein to dynamically update the graphical user interface, the processor is configured to:
display the plurality of updated skillsets as a second polygon with each radial axis of the second polygon defined by a respective updated skillset of the plurality of updated skillsets.

18. The system of claim 14, wherein the first user input comprises an overall skill level for an employee position type, and
wherein the determining the plurality of updated skillsets comprises:
determining the plurality of updated skillsets based on the overall skill level.

19. The system of claim 14, wherein the processor is further configured to:
determine a user career path,
wherein to determine the plurality of career skills, the processor is configured to:
determine the plurality of career skills based on the user career path.

20. The system of claim 14, wherein the first user input comprises a potential career path, and
wherein the processor is further configured to:
redetermine the plurality of career skills based on the potential career path;
dynamically update the spider web graph based on the redetermining the plurality of career skills;
redetermine the plurality of user skillsets based on the redetermining the plurality of career skills; and
dynamically update the plurality of user skillsets on the spider web graph based on the redetermining the plurality of user skillsets.
